(19) United States
(12) Patent Application Publication
(10) Pub. No.: US 2009/0076773 A1
(43) Pub. Date: Mar. 19, 2009

(54) Method for identifying unmeasured disturbances in process control test data

(75) Inventors: Hongbin Dong, Austin, TX (US); James B. Riggs, Lubbock, TX (US)

Correspondence Address: KAMMER BROWNING PLLC, 7700 BROADWAY, SUITE 202, SAN ANTONIO, TX, 78209, US

(73) Assignee: TEXAS TECH UNIVERSITY, Lubbock, TX (US)

(21) Appl. No.: 11/855,327

(22) Filed: Sep. 14, 2007

(51) Int. Cl. G06F 17/18; G06F 15/00

(52) U.S. Cl. 702/179; 702/185

(57) ABSTRACT

A method of improving a data set associated with a system, the method comprising: providing a baseline data set for the system, wherein the baseline data set comprises a plurality of input and output data from the system; analyzing the baseline data set and selecting a baseline model for the baseline data set, wherein the baseline model comprises an baseline array of data relating to the input and output data from the system; normalizing the baseline data set associated with the system to create a normalized data set; analyzing the normalized data set and selecting an improved model for the normalized data set, wherein the improved model comprises an improved array of data relating to the input and output data from the system; performing a statistical comparison using the baseline data set and the normalized data set; calculating an at least one indicator value associated with the normalized and baseline data set based on the statistical comparison; determining a threshold value associated with the baseline data set and normalized data set based on the statistical comparison; and producing a new data set by eliminating any segments of the baseline data set where the at least one indicator value is greater than the threshold value.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

This disclosure relates to data analysis and process control techniques. More specifically, this disclosure relates to model predictive control techniques and methods for identifying unmeasured disturbances in test data used in relation to model predictive control techniques.

Model predictive control (“MPC”) is a process control technique that has been used in various industries such as chemical plants and oil refineries to dynamically control the plant operations. A MPC model derives its operating values from measured plant data taken during testing of the plant operations. The measured data is used to train the MPC model to predict an accurate output based on the current state of the plant. Experience with MPC models has shown that using plant data from abnormal operating periods to train a MPC model can significantly undermine the control performance when these models are used for closed-loop control. As a result, detecting when a process variation occurs during gathering of the test data is essential to creating an accurate MPC model where such test data is used to train the model.

Process variations, which are also known as process noise, unmeasured disturbances, and process nonlinearity, can each affect the fidelity of MPC models developed from process training data. Process variations are the variations in the controlled variables due to colored noise or the coupling of regulatory PID-type controllers. Unmeasured disturbances include input changes (e.g., feed temperature and composition changes) and process changes (e.g., tuning parameter changes of the regulatory controllers and changing the line up of a process) that are not measured during plant testing. Process nonlinearity occurs in most systems and various transformations are used to reduce its effect in an associated data set. When a set of plant test data contains abnormal operating periods due to unmeasured disturbances, the fidelity of the identified model based on that test data can be degraded, resulting in significant mismatch between the identified model and the process.

Current techniques for taking the process variations into account focus on modeling the process disturbances. For example, stochastic disturbance models including Gaussian white noise models, low order stationary autoregressive moving average models, random walk models, and integrated moving average models have been used to take the process variations into account. However, in most cases where process disturbances dominate model error, modeling the process disturbances will not significantly improve the accuracy of identified process models. In these cases, the asymptotical model variance is proportional to the disturbance spectrum at any frequency.

### SUMMARY

A method of improving a data set associated with a system, the method comprising: providing a baseline data set for the system, wherein the baseline data set comprises a plurality of input and output data from the system; analyzing the baseline data set and selecting a baseline model for the baseline data set, wherein the baseline model comprises an baseline array of data relating to the input and output data from the system; normalizing the baseline data set associated with the system to create a normalized data set; analyzing the normalized data set and selecting an improved model for the normalized data set, wherein the improved model comprises an improved array of data relating to the input and output data from the system; performing a statistical comparison using the baseline data set and the normalized data set; calculating an at least one indicator value associated with the normalized and baseline data set based on the statistical comparison; determining a threshold value associated with the baseline data set and normalized data set based on the statistical comparison; and producing a new data set by eliminating any segments of the baseline data set where the at least one indicator value is greater than the threshold value.

A system for identifying unmeasured disturbances in a process comprising: a data entry unit, wherein the data entry unit accepts a baseline data set associated with the process, selects a baseline model for the baseline data set, normalizes the baseline data set and creates an improved data set from the normalized baseline data set, and selects an improved model for the improved data set; a modeling unit, wherein the modeling unit calculates a statistical threshold value using the baseline data set and the improved data set, calculates an indicator value using the baseline data set and the improved data set, and produces a new data set by eliminating any data in the baseline data set in which the indicator value is greater than the statistical threshold value; and a data output unit, wherein the data output unit outputs the new data set to a computer readable medium.

A process control device capable of implementing model predictive control of a process, the process control device performing a method comprising: identifying a first model predictive control model using a training data set associated with the process; identifying a second model predictive control model using a linearized training data set; statistically comparing the results of the first model predictive control model and the second model predictive control model; detecting differences in the statistical comparison of the first model predictive control model and the second model predictive control model; producing a new data set by eliminating any data in the training data set based upon the differences in the first model predictive control model and the second model predictive control model.

A method of identifying unmeasured disturbances in model predictive control test data comprising: identifying a first model predictive control model using a training data set; identifying a second model predictive control model using an improved training data set; calculating a global chi-squared value using the first model predictive control model, the second model predictive control model, the training data set, and the improved training data set; calculating an improved chi-squared threshold value; and producing a new data set by eliminating any data in the training data set in which the global chi-squared value is greater than the improved chi-squared threshold value.

### BRIEF DESCRIPTION OF THE DRAWINGS

For a detailed description of the preferred embodiments of the disclosure, reference will now be made to the accompanying drawings in which:

FIG. 1 is an overview of an embodiment of a system for identifying the unmeasured disturbances in test data.

FIG. 2 is a flowchart of an embodiment of a method for identifying the unmeasured disturbances in model predictive control test data.

FIG. 3 is a flowchart of an embodiment of a method for identifying model predictive control models from test data.

FIG. 4 is a flowchart of an embodiment of a method for identifying the values for comparison of the data and a threshold value.

FIG. 5 is a schematic diagram of an embodiment of a typical fluidized catalytic cracking unit.

FIG. 6 is a plot showing an example of the variations used in a plant test signal.

FIG. 7 is a plot showing an example of the improved threshold compared to the standard threshold.

FIG. 8 is another plot showing an example of the improved threshold compared to the standard threshold.

FIG. 9 is a plot showing an example of a model predictive control response curve.

FIG. 10a is a plot of the change in the feed composition ratio over time for a first cycle of testing during multiple amplitude changes.

FIG. 10b is a plot of the change in the chi-square value over time for a first cycle of testing during multiple amplitude changes.

FIG. 11a is a plot of the change in the feed composition ratio over time for a second cycle of testing during multiple amplitude changes.

FIG. 11b is a plot of the change in the chi-square value over time for a second cycle of testing during multiple amplitude changes.

FIG. 12a is a plot of the change in the feed composition ratio over time.

FIG. 12b is a plot of the change in the chi-square value over time.

FIG. 13a is a plot of the change in the feed composition ratio over time for a random walk disturbance.

FIG. 13b is a plot of the change in the chi-square value over time for a random walk disturbance.

FIG. 14 is another plot showing an example of a model predictive control response curve.

FIG. 15a is a plot of the change in the feed composition ratio over time for a first iteration of a random walk disturbance.

FIG. 15b is a plot of the change in the chi-square value over time for a first iteration of a random walk disturbance.

FIG. 16a is a plot of the change in the feed composition ratio over time for a second iteration of a random walk disturbance.

FIG. 16b is a plot of the change in the chi-square value over time for a second iteration of a random walk disturbance.

FIG. 17a is a plot of the change in the feed composition ratio over time for a third iteration of a random walk disturbance.

FIG. 17b is a plot of the change in the chi-square value over time for a third iteration of a random walk disturbance.

FIG. 18a is a plot of the change in the feed composition ratio over time for a fourth iteration of a random walk disturbance.

FIG. 18b is a plot of the change in the chi-square value over time for a fourth iteration of a random walk disturbance.

FIG. 19 is a plot showing an example of a model predictive control response curve for a random walk disturbance with multiple iterations.

FIG. 20a is a plot of the change in the feed composition ratio over time in a high noise environment.

FIG. 20b is a plot of the change in the chi-square value over time in a high noise environment.

FIG. 21 is another diagram showing an example of a model predictive control response curve in a high noise environment.

FIG. 22 illustrates an exemplary general purpose computer system suitable for implementing the several embodiments of the disclosure.

### DETAILED DESCRIPTION

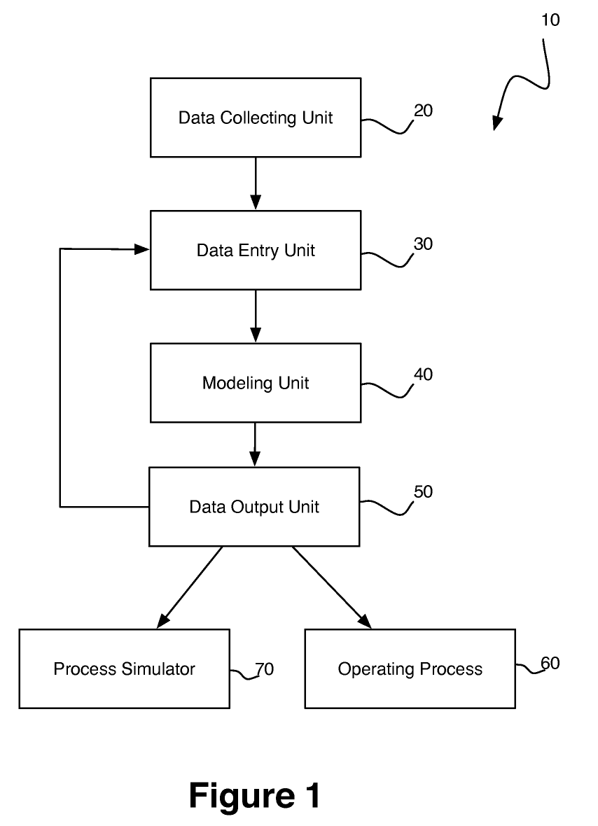

In an embodiment shown in FIG. 1, a modeling system for detecting unmeasured disturbances 10 in a process may contain a data collecting unit 20, a data entry unit 30, a modeling unit 40, a data output unit 50, an operating process 60 and a process simulator 70. Unmeasured disturbances may generally be described as any unmonitored variable that can affect a process under study (e.g., operating process 60). Examples of unmeasured disturbances include input changes, such as feed temperature or composition changes, or operating process changes, such as tuning parameter changes of the controllers that are not monitored. Data collecting unit 20 provides a baseline data set to data entry unit 30. This baseline data set may comprise a group of input and output measurements of the process (e.g., a set of actual data produced over an defined time period of the operating process 60, for example during a test run of the process), or a set of simulated input and output measurements of the process. Data entry unit 30 analyzes the baseline data set and passes the baseline data set and a normalized data set based on the baseline data set into modeling unit 40. Modeling unit 40 performs a statistical comparison of the data sets and outputs the result of the comparison to data output unit 50. Data output unit 50 may use the results of the statistical comparison to create a new data set based upon the removal of corrupted data from either one or both of the baseline data set or normalized data set. Data output unit 50 may transmit the new data set to a process simulator 70, operating process 60, back into data entry unit 30 for further unmeasured disturbance detection and correction, or combinations thereof.

The use of process data containing periods of unmeasured disturbances can result in models of the process (e.g., process simulator 70), such as an MPC model, to be corrupted. A corrupted model is may generally refer to a model that one that contains at least one error and does not accurately predict the process it is intended to model. It is understood that the process simulator 70 accuracy could be improved if corrupted data could be identified and removed from the training data set rather than taken into account in the model.

A baseline data set may be collected by data collection unit 20. The baseline data set may comprise a plurality of input and output data regarding the process or system (e.g., a plant process or operating unit) in which unmeasured disturbances are to be measured. This baseline data set may be the measurements taken from the process or may be generated by a computer performing a simulation of the process. This baseline data set may also be referred to as a training data set, training data, test data set, or a data set. Data collecting unit 20 may transmit one or more baseline data sets into data entry unit 30.

Data entry unit 30 may analyze the baseline data set and select a baseline model for the baseline data set. This baseline model may comprise a baseline array of data relating to the input and output data from the system. Data entry unit 30 also may normalize the baseline data set associated with the system to create a normalized data set. The term “normalize” is intended to refer to any mathematical operation which provides a more accurate representation of the process to which the modeling system for detecting unmeasured disturbances 10 is applied. Data entry unit 30 then analyzes the normalized data set and selects an improved model for the normalized data set. This improved model comprises an improved array of data relating to the input and output data from the process. Data entry unit 30 the passes the baseline data set and normalized data set into modeling unit 40.

Modeling unit 40 performs a statistical comparison using the baseline data set and the normalized data set, This statistical comparison allows modeling unit 40 to calculate at least one indicator value associated with the normalized and baseline data set based on the statistical comparison. Modeling unit 40 also may determine a threshold value associated with the baseline data set and normalized data set based on the statistical comparison. Modeling unit 40 may pass the results of the statistical comparison, including both the threshold value and the at least on indicator value, into data output unit 50. In some embodiments, modeling unit 40 may comprise an MPC model or MPC model component. For example, modeling unit 40 may be an MPC component such as the type called by or incorporated into an overall process simulator 70.

Data output unit 50 produces a new data set by eliminating any segments of the baseline data set where the at least one indicator value is greater than the threshold value. Data output unit 50 may then output the new data set to the process simulator 70, the operating process 60 (such as a real time process control system associated with the operating process 60), back into data entry unit 30 for further detection and correction of unmeasured disturbances, or combinations thereof.

Operating process 60 refers to any real world system or process that may be modeled or simulated (for example with process simulator 70), and for which operating data may be gathered, generated, or otherwise collected. Examples of operating process 60 include one or more process units in a manufacturing facility such as a chemical plant or petroleum refinery. The operating process 60 may include all or a portion of such chemical plants or petroleum refineries. Process simulator 70 may be any process model or simulation package, for example models and simulation programs available from SimSci-Esscor, WinSim, AspenTech, and others. In an embodiment, the process simulator 70 comprises an MPC model (and modeling unit 40 correspondingly relates to an MPC model), and the remainder of the disclosure will focus primarily on this non-limiting embodiment. The MPC model may comprise any model including, but are not limited to, Finite Impulse Response (FIR) models, transfer function models, and state-space models. In addition, the MPC model may be used to model a variety of system types. In an embodiment, the system being modeled may be a single-input, single-output (“SISO”) type model, a multiple-input, multiple-output type (“MIMO”) model, a single-input, multiple-output (“SIMO”) or multiple-input, single-output (“MISO”). For the purpose of clarity, the present disclosure focuses on a SISO type model. However it is expressly understood that the disclosed systems and methods may be used with any type of model.

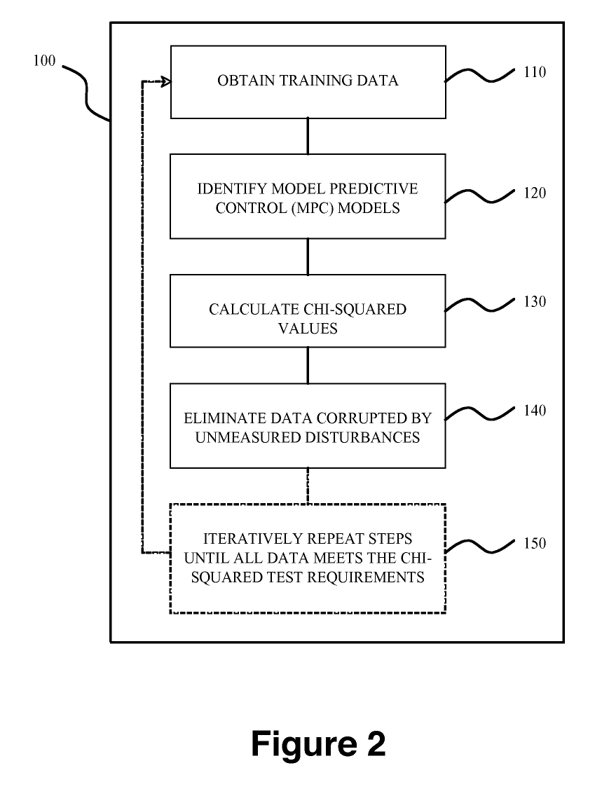

In an embodiment shown in FIG. 2, a method for detecting unmeasured disturbances 100 begins with collecting training data capable of being used for training a MPC model (Block 110). The training data may be acquired using actual plant operations, and may include data being recorded during the occurrence of process variations. The training data may also be obtained from simulated data based upon simulated plant operations.

Using this training data, a first MPC model may be identified and trained (Block 120). The first MPC model is identified by comparing the baseline data set with known models to determining which model best corresponds to the baseline data set. The training data set may be improved (e.g., normalized), for example through the use of piecewise linearization. The piecewise linearization of the training data set may be used as an improved data set. From this improved data set, the degree of linearization of the improved data set or of the baseline data set may be calculated.

While linearization is discussed, it is expressly understood any mathematical correction, including, but not limited to linearization may be used consistent with the present disclosure. The improved data set may be used to identify a more linear second MPC model.

The variance parameters of the first MPC model, second MPC model or both the first and second MPC model the may be calculated using chi-squared (χ²) values as indicators (Block 130). In this step, a covariance matrix and normalized residuals are calculated based on the MPC models, the training data set, and the improved data set. A global χ²value may be calculated from these values and compared to an improved threshold χ² value. Any data with a global χ² value greater than the improved χ² value may then be discarded (Block 140).

While this process creates a new data set that can be used to create an improved MPC model, the process may be repeated using the newly created data set until all of the global χ² values are lower than the improved χ² values (Block 150). This iterative process may continue until substantially all of the global χ² values are lower than the improved χ² values and may result in an improved MPC model.

The iterative method can be said to asymptotically approach the “true” process model. As used herein, the “true” process model represents the MPC model that most closely approximates the actual process and would be closely approximated by training a MPC model with test data having no process noise, process nonlinearity, or unmeasured process variations. The iterative method of the present disclosure may also be referred to as the Asymptotic Detection Method (“ADM)”). In order to more completely describe the method of the present disclosure, each process step is described in more detail below.

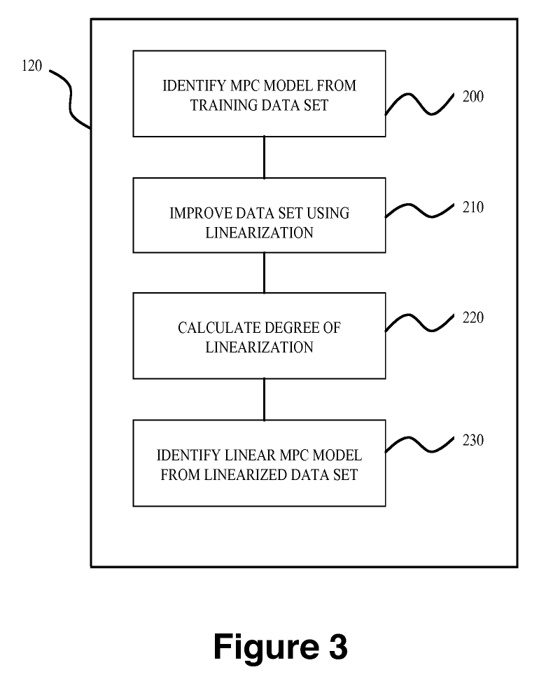

FIG. 3 is a flowchart of one method for identifing model predictive control models from test data. This method may correspond to Block 120 of FIG. 2. In this embodiment, the training data set may be used to identify a first MPC model (Block 200). Considering the observed variables for the output y(k) and observations for the inputs [(x(1), x(2), . . . x(k−1))], the MPC model can be expressed in a MPC form:

y(k)=g₁x(k−1)+g₂x(k−2)+ . . . +g₍ₖ₋₁₎x(1)+ε

where gᵢ(i=1, 2, . . . k−1) represents the coefficients of a MPC model between variables of y and x, and ε is a scalar of the scalar model prediction error.

The model parameter vector for MPC form may be expressed as:

G=[g₁, g₂, . . . gₖ₋₁]

The MPC model may be a linear or a nonlinear model, depending on the system being modeled. In an embodiment, a linear regression model may be used to represent the MPC model form and can be written as:

y(k)=GX^{T}(k−1)

where X(k−1) is:

X(k−1)=[x(1) x(2) . . . x(k−1)]

As an MPC model is identified by the model parameter vector, G, and model coefficients X(k−1), an MPC model may be referred to by the applicable model parameter vector. For example, the MPC model defined by model coefficients X(k−1) and model parameter vector G, may be referred to simply as MPC model G.

The MPC model coefficients may be determined, in one embodiment, using any type of regression analysis capable of determining the coefficients from the data set. It is expressly understood that any type of analysis capable of determining the coefficients from the data set may be used, including, but not limited to, a least-square regression. In one preferred embodiment, the least-square regression analysis is used to determine the coefficients of G.

Given the measured input-output sequence [y(1) X(0), y(2) X(1), . . . , y(N) X(N−1)], the objective function of the MPC model equation in linear form is minimized by the following:

$$\begin{matrix}V ( G ) = \frac{1}{N} {\sum }_{t = 1}^{N} {( \begin{matrix}y ( t ) - {g}_{1} x ( t - 1 ) - {g}_{2} x ( t - 2 ) - ⋯ - \\ {g}_{k - 1} x ( t - k + 1 )\end{matrix} )}^{2} \\ = \frac{1}{N} {\sum }_{t = 1}^{N} {( y ( t ) - G {X}^{T} ( t - 1 ) )}^{2}\end{matrix}$$

If the estimated parameters are denoted as G, then G may be calculated by solving the following equation:

$$\frac{\partial V ( G )}{\partial {g}_{i}} = - 2 \frac{1}{N} {\sum }_{t = 1}^{N} X ( t - 1 ) ( y ( t ) - G {X}^{T} ( t - 1 ) ) = 0$$

Based on this equation, the model parameter vector G should satisfy:

$$\frac{1}{N} {\sum }_{t = 1}^{N} X ( t - 1 ) ( y ( t ) - G {X}^{T} ( t - 1 ) ) = 0$$

Using this equation, a MPC model may be derived from the training data set. The first MPC model derived from the test data is characterized by and may be referred to as the MPC model G̅, and it represents a model potentially corrupted by data containing periods of unmeasured disturbances. This MPC model may form the basis of the analysis used to identify the unmeasured disturbances in the test data set.

In order to compare the first MPC model G̅ to a more accurate model, the more accurate model must be identified. Ideally, a “true” process model, sometimes identified as G₀, should be known in advance in order to compare it with the MPC model derived from the data set. The expression G₀ may refer to a “true” model or may refer to a model which is more accurate than the G̅ model. While a “true” process model is not generally available, the existing model can be improved by comparing G̅ to a more accurate process, referred to as G₀. Therefore, a better MPC model may be obtained by using an improved data set than may be derived from only the training data set used to train the first MPC model. It is known by one skilled in the art, that the normalized, or linearized data set, may form the basis for an improved model when compared to an unnormalized or unlinearized data set.

G₀ may be created using the first MPC model, using any technique capable of creating a MPC model closer to the “true” MPC model than the first MPC model. In one embodiment, the training data set may be improved using piecewise linearization (Block 210) to create the linearized data set. Piecewise linearization may be performed using a variety of techniques. In an embodiment, piecewise linearization begins by considering the input and output variables. The measurements of a controlled variable in the training data set at each sampling time, represented by [yₘ(1) yₘ(2) . . . yₘ(N)], will provide points on the line segment in the process variable domain; the predictions, [yₚ(1) yₚ(2) . . . yₚ(N)], corresponding to [yₘ(1) yₘ(2) . . . yₘ(N)] will yield points on the line segment in the transform domain. Within the range of the variables, a series of pairs of data (a measurement and its prediction) are selected to be the boundary points for the segments for the number of segments of interest. In each segment, a piecewise linear equation is regressed using its onset point and ending point, as shown by:

$${y}_{l} ( k ) = \frac{{y}_{m} ( k ) - {y}_{m} ( i )}{{y}_{m} ( j ) - {y}_{m} ( i )} \times ( {y}_{p} ( j ) - {y}_{p} ( i ) ) + {y}_{p} ( i )$$

where yₘ(k) represents the measurement and yₗ(k) is the linearized value of yₘ(k). [yₘ(i),yₚ(i)] and [yₘ(j), yₚ(j)] are the boundary points of a segment. By locating the interval [yₘ(i),yₘ(j)] in which yₘ(k) lies, the corresponding piecewise linearization equation is used to calculate yₗ(k), the linearized value. In an embodiment, the number of segments that may be linearized must be less than, or at most equal to, the number of sample data points.

The MPC model derived from the linearized data can then be used as the G₀ model in the equations derived in the present disclosure for identifying abnormal plant test data. Such approximation allows the “true” process model to be asymptotically approached by developing successive approximations using the method disclosed herein. The MPC model derived from linearization may therefore be referred to as the linear MPC model throughout the remainder of this disclosure. As the approximation of the more accurate process model, the linear MPC model may be denoted as G₀ unless otherwise specifically stated.

The degree of linearization of G₀ may be calculated and used in conjunction with equations, including, but not limited to, MPC equations to calculate the threshold values for determining if data is corrupted by unmeasured disturbances (Block 220). The degree of linearization represents the number of segments used in the linearization relative to the overall number of data points measured during testing. By adjusting the number of segments during linearization, different piecewise linear equations may be regressed, and different levels of nonlinearity of the linearized data sets can be obtained. In order to quantify the linear content of piecewise linearized data, the quantity:

$$D L = \frac{1}{N} \sum \vert \frac{( {y}_{l} ( t ) - {y}_{m} ( t )}{{y}_{p} ( t ) - {y}_{m} ( t ) )} \vert$$

is defined as the degree of linearization of the linearized data (“DL”), where yₜ is the linearized data, yₘ is the measurement, and yₚ is the prediction of yₘ. Using this definition, it may be shown that as the number of segments increases, the value of DL will asymptotically approach 1. Therefore, as a set of data is linearized with an increasing number of segments the value of DL approaches unity 1, i.e., DL=1. The equality, DL=1, will hold only if the number of segments is equal to the number of data points in the data sets. In an embodiment, the number of segments used to linearize the data is selected such that the value of DL is maintained from 0.2 and 0.8. In an alternative embodiment, the value of DL may be from 0.1 and 0.9.

Once the data set has been improved, another MPC model may be derived (Block 230) from the improved data set. In an embodiment, the linearized data set is used as the improved data set from which the second MPC model may be derived. The nonlinearity of the process data is one of the sources of mismatch between the MPC model and the actual process. Therefore, when the nonlinearity of training data set is reduced through piecewise linearization, a newly identified MPC model can be expected to more accurately predict the process data than when compared to the first WC model derived from the training data set corrupted by unmeasured disturbances. Since the newly identified MPC model derives from the improved data set, it will be referred to as the improved MPC model or the second MPC model throughout the remainder of the present disclosure, and, as previously discussed, it may be referred to as G₀ unless specifically noted otherwise. The improved MPC model is derived in the same manner as the first MPC model was derived, including the use of the same equations as described above. As also discussed above, the resulting improved MPC model is closer to the “true” process model than the first MCP model derived from the training data set. As a result, the improved MPC model can be used to asymptotically approach the true model.

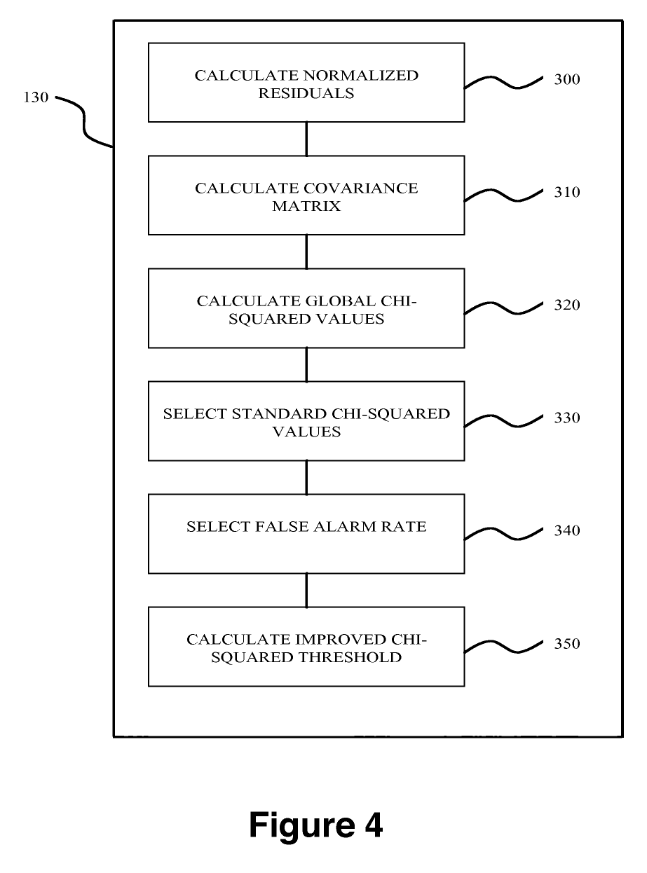

As shown in the method depicted in FIG. 4, the normalized residuals are calculated based on the training data set and the improved MPC model (Block 300). The covariance matrix is calculated based on the improved data set and the improved MPC model (Block 310). Using the normalized residuals, the first MPC model, and the improved MPC model, a global χ² value may be calculated (Block 320) for each segment in the training data set. An improved threshold for comparison to the global χ² value may be calculated by selecting a standard χ² value (Block 330), selecting a false alarm rate (Block 340), and then using these values to calculate an improved χ² value (Block 350). These values may be used to determine if a particular data segment from the training data set should be retained or discarded for use in subsequent training of a MPC model.

The normalized residual may be calculated and derived from the primary residual. Although the primary residual can be derived for a large sample of training data, the statistical distribution of the primary residual is rarely known in an embodiment. To overcome this problem, a known distribution of a new kind of residual derived from the primary residual may be generated by using the central limit theorem (CLT).

Given a primary residual K(G₀,Yₖ) characterized by the model G₀ and a sample number of N, the normalized residual is defined as:

$${ζ}_{N} ( {G}_{0} ) = \frac{1}{\sqrt{N}} {\sum }_{k = 1}^{N} K ( {G}_{0} , {Y}_{k} )$$

Compared with the primary residual, the normalized residual has the same mean value and covariance/variance as the primary residual. However, the most important characteristic of the normalized residual is that it will follow a Gaussian distribution, which simplifies the statistical analysis. The main difference between the primary residual and the normalized residual is that the primary residual is the general residual, which is a vector-valued function linking the process measurements and model parameters, while normalized residual is derived from the primary residual using the CLT, and will follow a Gaussian distribution.

In an embodiment, the normalized residual for the MPC models used herein may be derived using the definition of the normalized residual shown above. The normalized residual for the MPC models may be denoted using the form:

$$\begin{matrix}{ζ}_{N} ( G ) = \frac{1}{\sqrt{N}} {\sum }_{i = 1}^{N} X ( t - 1 ) [ y ( t ) - G {X}^{T} ( t - 1 ) ] \\ = \frac{1}{\sqrt{N}} {\sum }_{t = 1}^{N} X ( t - 1 ) ɛ ( t , G )\end{matrix}$$

which derives from the definition of ζ_{N}(G). Here, ζ_{N}(G) and K[G,y(t)] are both vectors, while as a scalar residual, ε(t,G) contains less information relevant to the data than the vectors. An aspect of the presently disclosed apparatus and method includes the result that if the model error ε(t,G) is used as the detection residual rather than the normalized residual ζ_{N}(G), an asymptotically sufficient statistic will not result. This result demonstrates that a residual with more information than a scalar is required to identify unmeasured disturbances in process data.

The normalized residual for the MPC model may be represented by defining:

$$Y = [ \begin{matrix}y ( k ) \\ y ( k + 1 ) \\ ⋮ \\ y ( n + k - 1 )\end{matrix} ] , X = [ \begin{matrix}x ( k - 1 ) & x ( k - 2 ) & … & x ( 0 ) \\ x ( k ) & x ( k - 1 ) & … & x ( 1 ) \\ ⋮ & ⋮ & ⋮ & ⋮ \\ x ( n + k - 2 ) & x ( n + k - 3 ) & … & x ( n - 1 )\end{matrix} ]$$

and letting Y̅ represent the prediction vector of the MPC model used to calculate the residual.

Then, the primary residual matrix K can be represented by:

$$\begin{matrix}K = [ \begin{matrix}{K}_{1} ( {G}_{0} , {Y}_{1} ) \\ {K}_{2} ( {G}_{0} , {Y}_{2} ) \\ ⋮ \\ {K}_{n} ( {G}_{0} , {Y}_{n} )\end{matrix} ] \\ = [ \begin{matrix}( {y}^{̑} ( k ) - y ( k ) ) x ( k - 1 ) & ( {y}^{̑} ( k ) - y ( k ) ) x ( k - 2 ) & … & ( {y}^{̑} ( k ) - y ( k ) ) x ( 0 ) \\ ( {y}^{̑} ( k + 1 ) - y ( k + 1 ) ) x ( k ) & ( {y}^{̑} ( k + 1 ) - y ( k + 1 ) ) x ( k - 1 ) & … & ( {y}^{̑} ( k + 1 ) - y ( k + 1 ) ) x ( 1 ) \\ ⋮ & ⋮ & ⋮ & ⋮ \\ ( {y}^{̑} ( n + k + 1 ) - y ( n + k + 1 ) ) x ( n + k - 2 ) & ( {y}^{̑} ( n + k + 1 ) - y ( n + k + 1 ) ) x ( n + k - 3 ) & … & ( {y}^{̑} ( n + k + 1 ) - y ( n + k + 1 ) ) x ( n - 1 )\end{matrix} ]\end{matrix}$$

and normalized residual can be written as:

$${ζ}_{N} ( G ) = \frac{1}{\sqrt{N}} {( {Y}^{̑} - Y )}^{T} X$$

In an embodiment, this equation is used to calculate the normalized residuals based on the training data set and the improved MPC model. The results are then used in a subsequent calculation to determine the global χ² values.

The covariance matrix may be calculated between the improved data set and the improved MPC model. The covariance matrix may be derived from the normalized residual, which in turn is based on a primary residual. Calculation of the primary residual begins with an initial theorem comprising two equations. Given a finite dimensional residual vector, K(G₀,Yₖ), where the process is accurately characterized by the model G₀ and is being represented by model G̅:

E _{G̅}[K(G₀, Yₖ)]=0 if G̅=G₀

E _{G̅}[K(G₀, Yₖ)]≠0 if G̅≠G₀

where E _{G̅} is the expectation value when the process is represented by the model G̅ and Yₖ is the process measurement at time unit k. K(G₀,Yₖ) is then referred to as the primary residual. For a finite sample of data, N the first equation of the theorem can be empirically rewritten as:

$$\frac{1}{N} {\sum }_{k = 1}^{N} K ( {G}_{0} , {Y}_{k} ) = 0$$

This expression can be regarded as the estimation function of G₀, which is also the loss function of process identification. The dimension of the primary residual should be greater than or equal to the order of the system parameter vector G₀.

A typical primary residual of a primary vector-valued function K(G₀,Yₖ) is the gradient with respect to the model coefficient, g of the summation of prediction error squared. For the loss function:

$$V ( g ) = \frac{1}{N} {\sum }_{k = 1}^{N} {e}_{k}^{2} ( g )$$

The following expression can be obtained by minimizing the loss function V(g) to solve for the unknown parameter g of the model:

$$\frac{\partial V ( g )}{\partial g} = \frac{2}{N} {\sum }_{k = 1}^{N} {e}_{k} \frac{\partial {e}_{k} ( g )}{\partial g} = 0$$

Then, if K(G₀,Yₖ) is set equal to

$${e}_{k} \frac{\partial {e}_{k} ( g )}{\partial g} ,$$

i.e.,

$$K ( {G}_{0} , {Y}_{k} ) = {e}_{k} \frac{\partial {e}_{k} ( g )}{\partial g}$$

then K(G₀,Yₖ) will obey the condition given by the first equation of the primary residual theorem if the new sample data set is collected from a process which is not corrupted by unknown process factors. Meanwhile, the second equation of the primary residual theorem will hold when the model is corrupted by unknown process factors. Therefore,

$${e}_{k} \frac{\partial {e}_{k} ( g )}{\partial g}$$

can be considered the primary residual in this case.

In an embodiment as disclosed herein, the primary residual for use with the MPC model form derived above may be derived using the equation for the primary residual as explained above. The MPC model, when generically identified by G, should satisfy:

$$\frac{1}{N} {\sum }_{t = 1}^{N} X ( t - 1 ) ( y ( t ) - G {X}^{T} ( t - 1 ) ) = 0$$

In addition, the term in the last parentheses is a quantity defined as:

y(t)−GX^{T}(t−1)=ε(t,G)

where ε(t,G) is the regularly scalar residual of the MPC model. The primary residual for a MPC model then becomes:

K[G,y(t)]=X(t−1)[y(t)−GX^{T}(t−1)]=X(t−1)ε(t,G)

due to

$$\frac{1}{N} {\sum }_{t = 1}^{N} [ X ( t - 1 ) ɛ ( t , G ) ] = 0 if G = {G}_{0}$$

$$and$$

$$\frac{1}{N} {\sum }_{t = 1}^{N} [ X ( t - 1 ) ɛ ( t , G ) ] \neq 0 if G \neq {G}_{0}$$

The value of the primary residual may be used to derive the normalized residual. This value can then be used with the method of the present disclosure for detecting unmeasured disturbances in process data.

Another approach to calculating the covariance matrix may use a Taylor series expansion. Assume

$$\frac{\partial {ζ}_{N} ( {G}^{̑} )}{\partial {G}^{̑}}$$

exists, then, apply a first-order Taylor series expansion to ζ_{N}( G̅) about G₀:

$${ζ}_{n} ( {G}^{̑} ) \approx {ζ}_{N} ( {G}_{0} ) + \frac{\partial {ζ}_{N} ( {G}^{̑} )}{\partial {G}^{̑}} {\vert}_{{G}^{̑} = {G}_{0}} ( {G}^{̑} - {G}_{0} )$$

Because ζ_{N}(G₀) is a Gaussian distribution with a zero mean, after the models have been corrupted, ζ_{N}( G̅) will converge to

$$( \frac{\partial {ζ}_{N} ( {G}^{̑} )}{\partial {G}^{̑}} {\vert}_{{G}^{̑} = {G}_{0}} ) ( {G}^{̑} - {G}_{0} ) .$$

The mean value of ζ_{N}( G̅) is not equal to zero due to G̅≠G₀,and the covariance matrix is equal to Σ(G₀). Therefore: ζ_{N}( G̅)˜N[0, Σ(G₀)] under the first equation of the primary residual theorem, and ζ_{N}( G̅)˜N[≠0, Σ(G₀)] under the second equation of the primary residual theorem. In these equations Σ(G₀) is the covariance matrix, and N[,] represents a normal distribution. The covariance matrix of the primary residual, Σ(G₀), theoretically is defined as:

$$\sum ( {G}_{0} ) = {lim}_{n -> ∞} {{ζ}_{N} ( {G}_{0} )}^{T} {ζ}_{N} ( {G}_{0} )$$

In order to simplify the calculations in an embodiment, the whole data sequence is divided into the M segments of data length L and in each segment the normalized residual is calculated as:

$${ζ}_{M , L} ( {G}_{0} ) = \frac{1}{\sqrt{N}} {\sum }_{l = 1}^{L} {K}_{l + ( M - 1 ) L} ( {G}_{0} , {Y}_{l + ( M - 1 ) L} )$$

Then, with a finite sample size, the covariance matrix is represented by the equation:

$$\sum ( {G}_{0} ) = \frac{1}{M} {\sum }_{m = 1}^{M} {ζ}_{m , L}^{T} ( {G}_{0} ) {ζ}_{m , L} ( {G}_{O} )$$

In an embodiment, the covariance matrix, as represented by the equation above, is used to calculate the covariance between the improved data set and the improved MPC model, which approximates the “true” process model. The results are then used in combination with the results from the calculation of the normalized residuals between the training data set and the improved MPC model in the calculation of the global χ² values.

The global χ² values may be calculated using the normalized residuals and covariance matrix. In one preferred embodiment, detecting corrupted process data involves determining if the mean value of ζ_{N}( G̅) has changed. Using a Gaussian distributed vector, the generalized likelihood ratio test (GLR) can detect unknown changes in the mean of a Gaussian distributed vector. The resulting analysis is a χ² test represented by:

χ_{global}²=ζ_{N}( G̅)^{T}Σ⁻¹(G₀)ζ_{N}( G̅)

The degree of χ² is equal to the order of the model. The value obtained from this calculation for each segment will be used to determine if the data is corrupted by unmeasured disturbances and should be discarded.

An improved χ² value may be calculated after the selection of a standard χ² value and a false alarm rate. The threshold for the false alarm date will be determined by the algorithm to be used. An improved χ² value may be required due to the nonlinearities in the system. Because the number of segments used in the piecewise linearization will affect the DL and can be chosen arbitrarily in principle, the degree of linearization can affect the detection method. As a result, the use of the calculation to detennine the global χ² value, also denoted as χ_{global}² in the equations that follow, for identifying corrupted data requires a threshold that is dependent on the degree of linearization used.

As previously discussed, the training data set may be improved using a variety of methods. In an embodiment, the nonlinear content of a training data set can be reduced by the use of piecewise linearization. The number of segments will affect the linearity of the transformed data, which can be quantified by the quantity, DL. When more segments are used for the piecewise linearization, the transformed data will asymptotically become more linear. That is, DL will asymptotically approach unity as the number of segments is increased. Consequently, the MPC model quality should improve due to the linearization. Therefore, if the MPC model error is dominated by process nonlinearity rather than by unmeasured disturbances, the detection algorithm will be more sensitive to process nonlinearity. As a result, the detection algorithm can issue a large number of false alarms. In order to overcome this limitation, the standard χ² threshold value should be revised to circumvent false alarms due to the nonlinearity of a training data set. The new threshold value of χ² should be as small as possible so that the detection performance is approximately lossless. In addition, the smaller threshold of the new χ² value will make the detection test more sensitive not only to unmeasured process disturbances but also to other factors, such as process nonlinearity. The new χ² value that results from the analysis represents an improved threshold relative to the standard χ² threshold. As a result, it will be referred to as an improved χ² threshold value throughout the remainder of the present disclosure. The issue of an improved χ² threshold can be based on an embodiment in which the training data set is improved through the use of linearization as follows:

1. Because the proposed detection algorithm is based on the piecewise linearization, it is naturally assumed that the improved threshold global χ² value should be a function of the DL, i.e.,

χ_{improved}²=ƒ(DL)

2. The improved threshold χ² value, also denoted as χ_{improved}², should keep at least the same false alarm rate as the standard χ² value, also denoted as χ²standard, with respect to the unmeasured process disturbances. In other words, if there are no unmeasured process disturbances, then

χ_{standard}²<χ_{global}²<χ_{improved}²

If there exist data corrupted by unmeasured disturbances, then:

χ_{global}²>χ_{improved}²>χ_{standard}²

3. To maintain the sensitivity of the detection method to unmeasured process disturbances, the improved χ² threshold value should be chosen as small as possible.

The objective of improving the threshold is to find a new threshold for the global χ² value for which the false rate P(χ_{global}²>χ_{improved}²) is less than the false alarm rate of

P(χ_{global}²>χ_{standard}²).

Then, the following may hold:

χ_{standard}²≦χ_{improved}²

And the following results:

1−P(χ_{global}²>χ_{improved}²)>1−P(χ_{global}²>χ_{standard}²)=1−α

where α is a predefined false alarm rate.

The issue of improving the threshold is converted into the problem of how to set up a new threshold based on DL and other available information while keeping it as small as possible. In an embodiment, the solution begins with the Taylor series expansion of the normalized residual. Given ζ_{N}(G₀) and ζ_{N}( G̅), ζ_{N}( G̅) can be approximated at G₀ by a first-order Taylor series:

$${ζ}_{N} ( {G}^{̑} ) \approx {ζ}_{N} ( {G}_{0} ) + \frac{\partial {ζ}_{N} ( {G}^{̑} )}{\partial {G}^{̑}} {\vert}_{{G}^{̑} = {G}_{0}} ( {G}^{̑} - {G}_{0} )$$

Where G̅ and G₀ are the parameter vectors of identified models which are regressed using the training data set (Xₖ,Yₖ) and the improved data set [Xₖ,(Y_{L})ₖ], respectively. From the definition of normalized residual ζ_{N}( G̅), it can be proven that

$$\frac{\partial {ζ}_{N} ( {G}^{̑} )}{\partial {G}^{̑}}$$

is equal to (using the normalized residual equation), i.e.,

$$\frac{\partial {ζ}_{N} ( {G}^{̑} )}{\partial {G}^{̑}} = \frac{1}{\sqrt{N}} {\sum }_{k = 1}^{N} {X}_{k}^{T} {X}_{k}$$

By the least square identification methodology, there may be:

$${G}_{0} = {( {\sum }_{k = 1}^{N} [ {X}_{k}^{T} {X}_{k} ] )}^{- 1} {\sum }_{k = 1}^{N} {{X}_{k}^{T} ( {Y}_{L} )}_{k}$$

$${G}^{̑} = {( {\sum }_{k = 1}^{N} [ {X}_{k}^{T} {X}_{k} ] )}^{- 1} {\sum }_{k = 1}^{N} {X}_{k}^{T} {Y}_{k}$$

Substituting these two equations into the Taylor series expansion, the equation becomes

$${ζ}_{N} ( {G}^{̑} ) \approx {ζ}_{N} ( {G}_{0} ) + \frac{1}{\sqrt{N}} {\sum }_{k = 1}^{N} {X}_{k}^{T} [ {Y}_{k} - {( {Y}_{L} )}_{k} ]$$

Noting the definition of DL, for the sake of simplicity if it is assumed:

$$\frac{{Y}_{L} ( t ) - Y ( t )}{{Y}_{P} - Y ( t )} > 0$$

Then the following can be obtained:

(Y_{L})ₖ−Yₖ=DL((Y_{P})ₖ−Yₖ)

After substituting, the equation can be rewritten as:

$${ζ}_{N} ( {G}^{̑} ) \approx {ζ}_{N} ( {G}_{0} ) + \frac{1}{\sqrt{N}} {\sum }_{k = 1}^{N} {X}_{k}^{T} DL [ {Y}_{k} - {( {Y}_{p} )}_{k} ]$$

A new threshold for ζ_{N}( G̅) may then follow the equation:

χ_{global}²=ζ_{N}( G̅)^{T}Σ⁻¹(G₀)ζ_{N}( G̅)

replacing ζ_{N}( G̅) leads to:

$${χ}_{global}^{2} = {( {ζ}_{N} ( {G}_{0} ) + \frac{1}{\sqrt{N}} {\sum }_{k = 1}^{N} {X}_{k}^{T} DL [ {Y}_{k} - {( {Y}_{p} )}_{k} ) ]}^{T} \times {\sum }^{- 1} ( {G}_{0} ) \times ( {ζ}_{N} ( {G}_{0} ) + \frac{1}{\sqrt{N}} {\sum }_{k = 1}^{N} {X}_{k}^{T} DL [ {Y}_{k} - {( {Y}_{p} )}_{k} ) ]$$

this can be expanded as:

$${χ}_{global}^{2} = {{ζ}_{N} ( {G}_{0} )}^{T} {\sum }^{- 1} ( {G}_{0} ) {ζ}_{N} ( {G}_{0} ) + 2 {{ζ}_{N} ( {G}_{0} )}^{T} {\sum }^{- 1} ( {G}_{0} ) \frac{1}{\sqrt{N}} {\sum }_{k = 1}^{N} {X}_{k}^{T} DL [ {Y}_{k} - {( {Y}_{p} )}_{k} ) ] + {[ \frac{1}{\sqrt{N}} {\sum }_{k = 1}^{N} {X}_{k}^{T} DL ( {Y}_{k} - {( {Y}_{p} )}_{k} ) ]}^{T} {\sum }^{- 1} ( {G}_{0} ) [ \frac{1}{\sqrt{N}} {\sum }_{k = 1}^{N} {X}_{k}^{T} DL ( {Y}_{k} - {( {Y}_{p} )}_{k} ) ]$$

For any n-dimension vector A and B, it can be shown that:

2A^{T}B≦A²+B

Furthermore, the standard threshold, χ_{standard}², can be selected from a standard table and a false alarm rate may be specified such that:

ζ_{N}(G₀)^{T}Σ⁻¹(G₀)ζ_{N}(G₀)<χ_{standard}²

Apply these two equations to the expanded equation for χ_{global}² results in:

$${χ}_{global}^{2} = {{ζ}_{N} ( {G}_{0} )}^{T} {\sum }^{- 1} ( {G}_{0} ) {ζ}_{N} ( {G}_{0} ) + 2 {{ζ}_{N} ( {G}_{0} )}^{T} {\sum }^{- 1} ( {G}_{0} ) \frac{1}{\sqrt{N}} {\sum }_{k = 1}^{N} {X}_{k}^{T} DL [ {Y}_{k} - {( {Y}_{p} )}_{k} ] + {[ \frac{1}{\sqrt{N}} {\sum }_{k = 1}^{N} {X}_{k}^{T} DL ( {Y}_{k} - {( {Y}_{p} )}_{k} ) ]}^{T} {\sum }^{- 1} ( {G}_{0} ) [ \frac{1}{\sqrt{N}} {\sum }_{k = 1}^{N} {X}_{k}^{T} DL ( {Y}_{k} - {( {Y}_{p} )}_{k} ) ] < 2 {χ}_{defined}^{2} + {2 [ \frac{1}{\sqrt{N}} {\sum }_{k = 1}^{N} {X}_{k}^{T} DL ( {Y}_{k} - {( {Y}_{p} )}_{k} ) ]}^{T} {\sum }^{- 1} ( {G}_{0} ) [ \frac{1}{\sqrt{N}} {\sum }_{k = 1}^{N} {X}_{k}^{T} DL ( {Y}_{k} - {( {Y}_{p} )}_{k} ) ]$$

The second term on the right hand side of this equation can be defined as:

$${φ}^{2} = ( \frac{1}{\sqrt{N}} DL \sum {{X}_{k}^{T} [ {Y}_{k} - {( {Y}_{p} )}_{k} ]}^{T} {\sum }^{- 1} ( {G}_{0} ) ( \frac{1}{\sqrt{N}} DL \sum {X}_{k}^{T} [ {Y}_{k} - {( {Y}_{p} )}_{k} ) ]$$

Then the following results:

χ_{global}²≦2χ_{standard} ²+2φ²

As stated before, the new threshold should preferably be as small as possible in order to reinforce the efficiency of the prediction algorithm. On the other hand, it is easy to prove that the minimum value of right hand side is:

$$2 {χ}_{standard}^{2} + 2 {φ}^{2} \geq {χ}_{standard}^{2} + {φ}^{2} + 2 \sqrt{{χ}_{standard}^{2}} \sqrt{{φ}^{2}} = \sqrt{{χ}_{standard}^{2}} + \sqrt{{φ}^{2}}$$

This becomes:

Min{2χ_{defined}²+2φ²}=\sqrt{χ_{standard}²}+\sqrt{φ²}

Then, a new threshold for the asymptotical detection method for an embodiment utilizing piecewise linearization can be expressed as:

χ_{improved}²=(\sqrt{χ_{standard}²}+\sqrt{φ²})²

While a number of equations for determining a new threshold for comparison with calculated χ² values may be determined, the value of χ_{improved}² is calculated using this equation in a preferred embodiment.

The values of χ_{improved}² and χ_{global}² calculated may be used to determine which data is corrupted by unmeasured disturbances. Any data identified as corrupted is then eliminated from the data set used for training. In an embodiment, any data with a χ_{global}² value larger than the value of χ_{improved}² may be marked as corrupted data and eliminated from the data set. The resulting data set is a new data set with the portion of the data being measured during an unmeasured disturbance removed. This new data set may then be used to generate a new MPC model that represents an improvement over the previously derived first MPC model using the corrupted data. The new MPC model may then be used with a process control system for prediction and control of one or more systems. Alternatively, the new data set and the new MPC model may be used with subsequent iterations of the presently disclosed method.

As discussed previously, it is expressly understood that the disclosed systems and methods described herein may optionally be repeated iteratively. In these embodiments, the new data set created from an iteration becomes the training data set upon the next iteration. The new MPC model then becomes the first MPC model in the next iteration and is used in determining if any additional portions of the data have resulted from unmeasured disturbances. In some of these embodiments, a final data set is obtained when all of the data retained and not eliminated by the disclosed process has a χ_{global}² value that is less than the value of χ_{improved}². In some other embodiments, the final data set may be obtained once substantially all of the χ_{global}² values are less than the χ_{improved}² values. The final data set obtained from the iterative process may be used to obtain a MPC model that represents an improvement over the MPC models that may be obtained using the data set containing corrupted data due to unmeasured disturbances.

The apparatus and method having been generally described, the following examples are given as particular embodiments and to demonstrate the practice and advantages thereof. It is understood that the examples are given by way of illustration and are not intended to limit the specification or the claims in any manner.

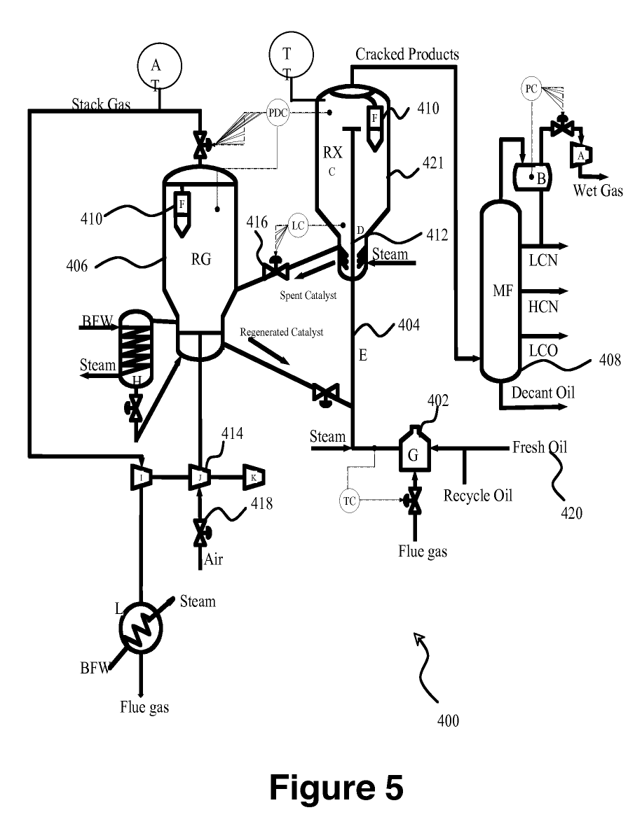

In the examples presented herein, a detailed fluidized catalytic cracking (FCC) unit was modeled using a process simulator to represent the real process. An FCC process is an important unit in a modern refinery because it converts low value gas oil to high value gasoline and light gases. A typical FCC process 400 is shown in FIG. 5. The hydrocarbon feedstock is preheated in a feed pre-heater 402, indicated as “G” on FIG. 5 before entering a riser 404, indicated as “E” where it is first mixed with and vaporized by the hot regenerated catalyst from a regenerator 406, indicated as “RG”. Endothermic catalytic cracking reactions take place as the hydrocarbon rises along the length of the riser 404 into a reactor 421 indicated as “RX”. Lighter hydrocarbon products are produced along with by-product coke, which is deposited on the surface of catalyst and decreases the catalytic activity. The main product vapor goes into a main fractionator unit 408, indicated as “MF” where different products are separated. The deactivated catalyst is separated in a cyclone 410, indicated as “F” and falls into the stripping section 412, indicated as “D” where the residual products on the catalyst are stripped by stripping steam. The spent catalyst from the stripping section goes into the regenerator 406 through a transport line. In the regenerator 406, the coke is burned off by the air from the air blower 414, indicated as “J”. After the removal of coke from the surface of the catalyst, the activity of the catalyst is renewed while releasing heat due to burning the coke, which heats the catalyst to a temperature sufficient to vaporize the feed and to maintain the temperature in the riser 404. The regenerated catalyst is brought into the riser by another transport line 422. Thus, the regenerated catalyst continuously enters the riser 404 and the spent catalyst comes into the regenerator 406 providing a cyclic continuous reaction process. The controlled variables (CVs) and manipulated variables (Mvs) of MPC models for the FCC process are listed in Table 1. The MVs are the valve position for a slide valve 416 on the line from the regenerator 406 to the riser 404, and valve position on a valve 418 for the airflow to the regenerator 406, where the CVs are the riser temperature and the oxygen concentration in the stack gas.

TABLE 1
Process variables for MPC models

| Manipulated Variables (MVs) | | Controlled Variables (CVs) | |
|---|---|---|---|
| Symbol | Description | Symbol | Description |
| u₁ | Valve position (RG to RX) | y₁ | Riser outlet Temperature |
| u₂ | Valve position (Blower to | y₂ | O₂ Concentration of |
| | RG) | | stack gas |

For FCC processes, feed composition variation is a typical source of unmeasured process disturbance because it changes irregularly with time and affects the quality of product and the performance of the process. For this example, the ratio of heavy oil to light oil in the fresh oil feed 420 is used as the unmeasured disturbance. Significant changes in the ratio can result in significant changes in process behavior. The initial base case-value of the heavy oil to light oil ratio was set equal to 1.

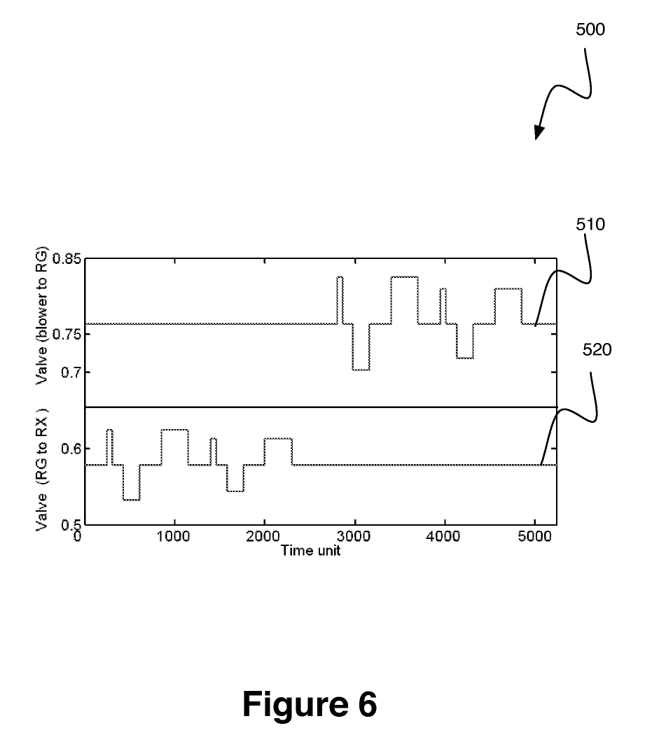

The asymptotic detection method was used to evaluate the efficiency of detecting unmeasured process disturbances in a MPC plant test data set generated using the FCC simulation. FIG. 6 is a plot illustrating two sets of data of a plant test signal for manipulated variables. The plant test signal applied is shown in FIG. 6 measured at two separate points, each plotted against time. The first measured signal 510 is taken at valve 418. The second measured signal 520 is taken at valve 416. The X-axis for both plots is the time taken of each, and the Y-axis is the measurement of the vale.

When conducting industrial plant tests, plant test signals are designed for each manipulated variable, the holding time for the step changes are 1τₚ, 2τₚ, 3τₚ, 4τₚ, and 5τₚ, respectively, where τₚ is a process time constant. FIG. 6 is an illustration of the step changes in the MVs used to develop the MPC models in this example. In the example illustrated by FIG. 6, it was further assumed that the process noise level is limited to a certain range that would not significantly corrupt the MPC models. That is, the noise levels used were based on assuming that properly functioning sensors were used to collect the plant test data. The sensor noise was modeled as Gaussian colored noise. The repeatabilities for the temperature sensor and the O₂ analyzer were ±1.1K and ±0.002, respectively.

The examples presented herein are considered a training data set for a MPC model between the riser outlet temperature (y₁) and the slide valve position from RG to RX (u₁). Using this information, the first example investigated a set of process data based on a step test without unmeasured disturbances to determine the best available (“true”) process model using no process noise and applying piecewise linearization to the data to reduce the effect of process nonlinearity. In the second through the fifth examples, unmeasured disturbances in the feed composition were investigated. Finally, a sixth example is used to demonstrate the effects of process noise on the disclosed method's ability to detect unmeasured disturbances. Even though the ADM was applied and tested using FIR-type MPC models in the examples, the ADM is not limited to FIR models.

### EXAMPLE 1

The process training data for the effect of u₁ on y₁ was collected for the case without an unmeasured disturbance. The least-squares method was used to identify the MPC model for y₁−u₁. Applying piecewise linearization to the raw training data to generate the linearized data set, the DL was calculated to be approximately equal to 0.3. The linearized data was used to re-identify a new MPC model betweeny, y₁−u₁. The covariance matrix Σ(G₀) was estimated using this linearized training data set and its MPG model. To reduce the computational load and guarantee a positive definite covariance matrix, the covariance estimate was sequentially based on a sliding window with a sample size N equal to 100. The χ_{global}² of the raw training data was calculated from the sliding window with a sample size N equal to 350.

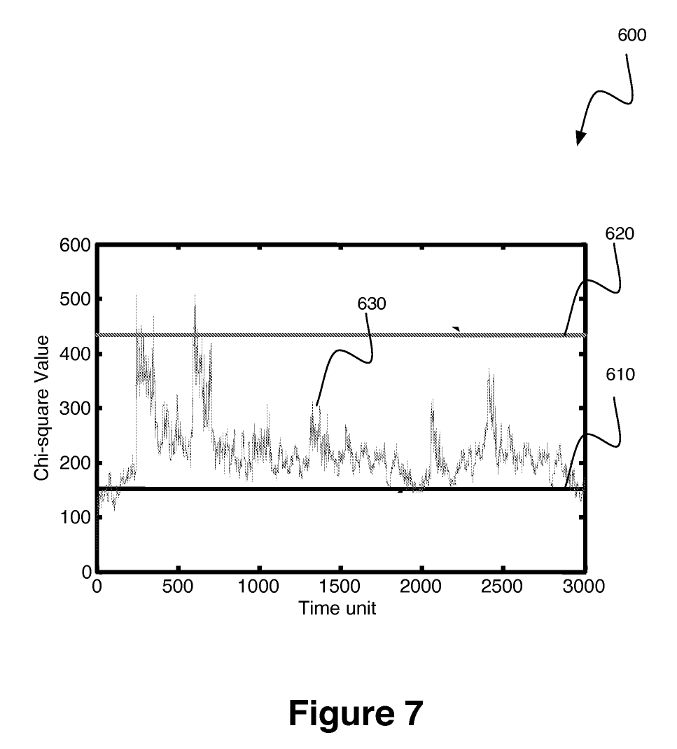

FIG. 7 is a plot 600 of the data obtained through the disclosed method where there are no disturbances. Data plot 630 is a plot of the Chi-Square Value on the Y-axis against time plotted on the X-axis. The standard threshold 610 was 152.21 obtained from the standard χ² table by selecting false alarm α=0.025. Following the definition of φ² and substituting DL, Y, Y̅, and Σ(G₀) into the equation for φ², φ² is equal to 72.41. The improved threshold 620 was calculated as follows:

χ_{improved}²=(\sqrt{152.21}+\sqrt{72.41})²=434.59

The data plot 630 of χ² values shown in FIG. 7 illustrate that the improved threshold can significantly decrease the rate of false alarms. The data plot 630 exceeds the standard threshold 610 throughout this plot. However, since there are no disturbances in this data, data plot 630 should, theoretically, rarely exceed the standard threshold 610. Since whenever the standard threshold 610 is exceeded by the data plot 630 there is a false alarm, FIG. 7 illustrates that the standard threshold 610 gives rise to many false alarms. Using the improved threshold 620, there will be very few false alarms as the data plot 630 rarely exceeds the level of the improved threshold 620.

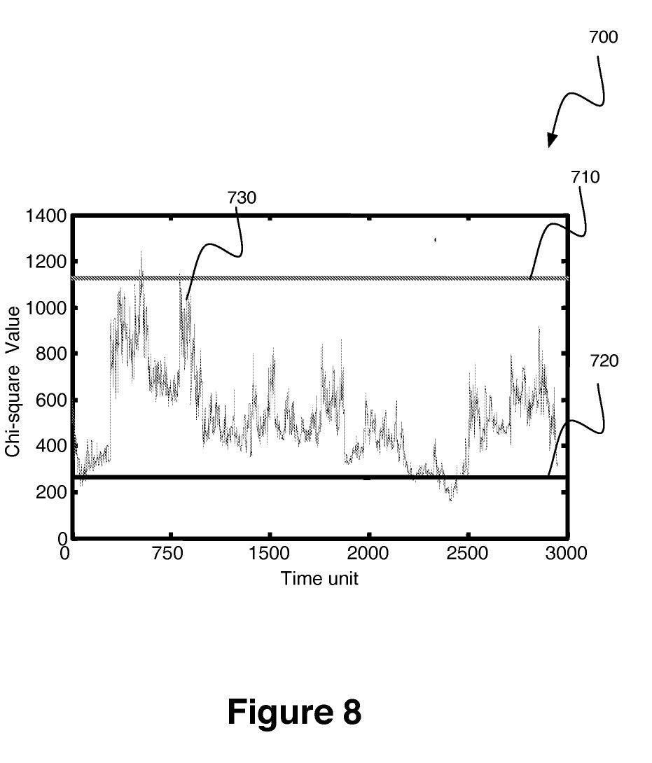

FIG. 8 is a plot 700 similar to FIG. 7, except that the DL value was increased to 0.7 by adjusting the number of segments applied for piecewise linearization. The data plot 730 of the Chi-Square Value on the Y-axis against time plotted on the X-axis. The standard threshold 720, as known by one skilled in the art, is 152.21. Applying the same procedures as described in the above case, φ² was calculated to be equal to 453.69. Then the improved threshold 710 was calculated to be:

χ_{improved}²=(\sqrt{152.21}+\sqrt{453.69})²=1128.7

As in FIG. 7, the data plot 730 exceeds the standard threshold 720 in numerous locations, but rarely exceeds the improved threshold 710.

From these two figures, it can be seen that using the improved threshold can improve the reliability of the asymptotical detection method. As a result, the detection algorithm should be less sensitive to process nonlinearity contained in the training data set even though the model error primarily results from the process nonlinearity. Moreover, results clearly indicate that the detection method is independent of the value of DL when the standard threshold is replaced with the improved threshold.

### EXAMPLE 2

For the FCC process simulation, variations in the feed composition were assumed to be the source of unmeasured process disturbance because it affects the MPC model quality. The initial value of the heavy to light feed ratio was set equal to 1. Two kinds of unmeasured disturbances were considered in these examples, one was a step change and another one was a random walk variation.

This example considers a step change in the feed composition. For a step change in the unmeasured disturbance, the single step change in the unmeasured disturbance followed by a step change return to its initial value in each plant test was first considered; then, the case with multiple levels of step changes in the unmeasured disturbances in one plant test data set was considered in the next example.

During the plant test, the feed composition (ratio of heavy oil to light oil) was changed from 1 to 1.42 at time unit 500 and returned to the original value (1.0) at time unit 1400. Based on including the abnormal training data, the MNC model y₁−u₁ was identified.

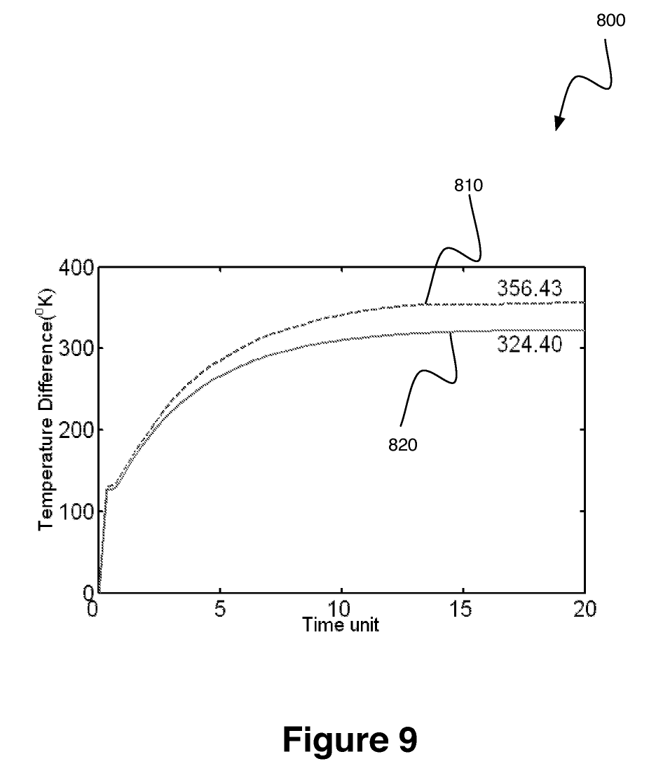

FIG. 9 is a plot 800 illustrating a model comparison between true model and actual test data for a step change in the unmeasured disturbances. True model data 810 is shown with test data 820. Both true model data 810 and test data 820 are plotted with time as the X-Axis and the temperature change during the process recorded. This figure, when compared to the true model, shows that the test data was changed by the unmeasured disturbance. This confirms the existence of the unmeasured disturbance.

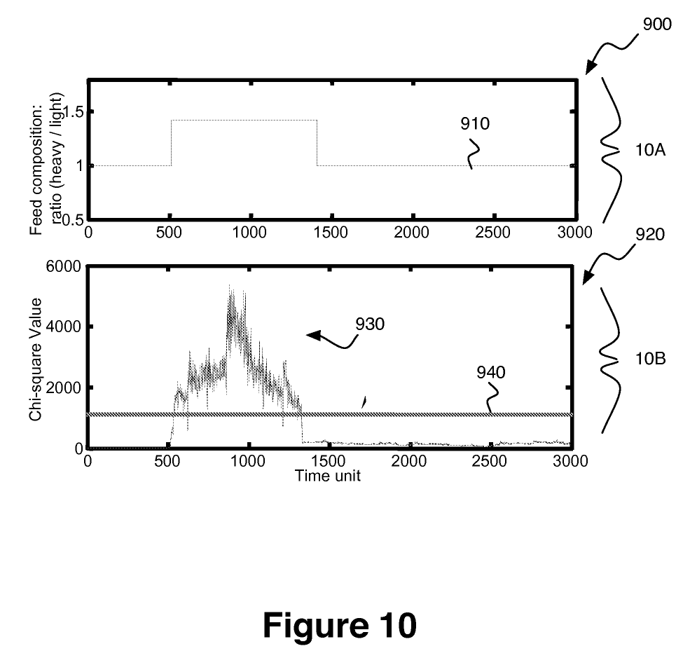

The results of applying the proposed detection algorithm to this training data are shown in FIG. 10a and FIG. 10b, where the DL was equal to 0.7. FIG. 10a is a plot 900 showing data 910 which represents the change in the feed composition ratio over time. FIG. 10b is a plot 920 showing data 930 which represents the change in the chi-square value over time. The change in the feed composition is known to have taken place at the time unit of 500. FIG. 10a and FIG. 10b show that for the feed composition change, the detection method was able to detect the abnormal data. The results indicated that the asymptotical detection method was able to identify the majority of the step change in the unmeasured disturbance. The elimination of the majority of the data recorded during the unmeasured disturbance produces a model that is more accurate than the model produced from the data corrupted by the unmeasured disturbance. This removal of data creates the improved threshold 940 shown.

### EXAMPLE 3

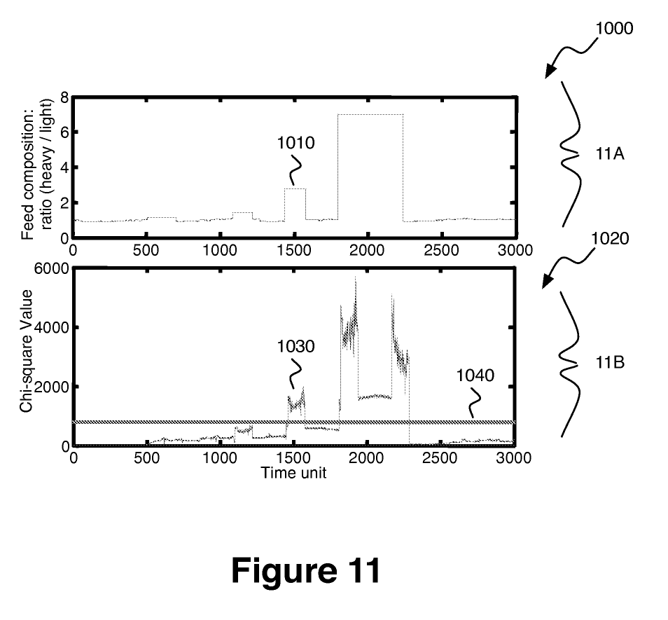

In most industrial processes, unmeasured process disturbances like feed composition changes do not occur at a constant upset level during the MPC plant test, but rather the scale of unmeasured disturbances vary with time. In order to study these types of changes a series of step changes in the unmeasured was considered. FIG. 11a is a plot 1000 showing data 1010 of the change in the feed composition ratio over time,

Step changes in the ratio of heavy to light feed, with step magnitudes 1.14, 1.42, 2.8, and 7.0, were introduced sequentially during one plant test, which are shown in FIG. 11a. The asymptotical detection algorithm was applied to the training data set obtained using the multiple step changes, where the DL was adjusted to approximately 0.7. FIG. 11b is a plot 1020 of the change in the chi-square value over time. In FIG. 11b, it can be seen that when the training data was corrupted by multi-levels of step changes in the unmeasured disturbance, the detection method first identified the data corrupted by largest unmeasured disturbances, i.e., step magnitudes 2.8 and 7.0 simultaneously. After removing these corrupted data from the training data set, the corrupted data in the rest of training data could be identified and removed until all significant disturbances are removed. This created the improved threshold 1040 which was found to be 798.19.

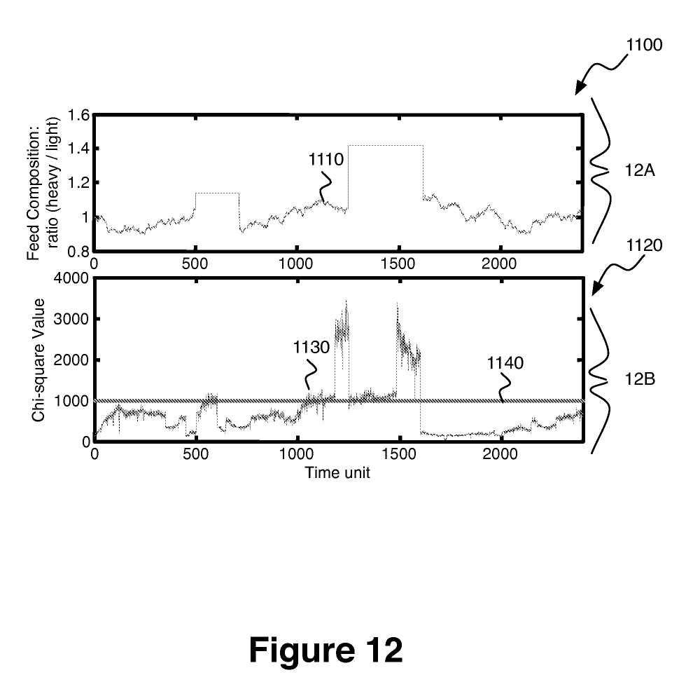

FIG. 12a and FIG. 12b show the second cycle of testing where multiple-amplitude step changes in the unmeasured disturbances after first slicing out some of the corrupted data. Since the improving of the MPC model may take place in one or more iterative cycles, a second cycle is illustrated by FIG. 12a and FIG. 12b, where FIG. 12a shows the original testing data and FIG. 12b shows the result of the testing after data which is known to be corrupt is removed. FIG. 12a is a plot 1100 showing data 1110 of the change in the feed composition ratio over time. The data which is known to be corrupt is then removed. The asymptotical detection algorithm was applied to the training data set obtained using the multiple step changes, where the DL was adjusted to approximately 0.7. FIG. 12b is a plot 1120 showing data 1130 of the change in the chi-square value over time after the corrupt data is removed and the asymptotical detection algorithm was applied to the training data set. The results indicate that the ADM was successful in identifying the majority of the time periods during which unmeasured disturbances were present in the test data as shown by the improved threshold 1140. Additional iterations of the presently disclosed method may have resulted in the elimination of a greater portion of the data occurring during the unmeasured disturbances, but further iterations were not performed as part of this example.

### EXAMPLE 4

Similar to the case of a step change in the unmeasured disturbance, two groups of random walk unmeasured disturbances were considered: (1) a single magnitude random walk unmeasured disturbance and (2) multiple random walk changes with different magnitudes in the unmeasured disturbance. This example illustrates the single magnitude random walk unmeasured disturbance. For the single magnitude random walk disturbance case, random walk changes for the unmeasured disturbance were scaled by 0.03. Multiple scales were used for the series of random walk changes in the unmeasured disturbance.

In this example, an autoregressive model was used to model process unmeasured disturbances. The autoregressive model takes the form:

X(k+1)=X(k)+e(k)

where X(0) was set equal to the initial value of the disturbance variable, 1, and e(k) is white noise. By taking different values of the standard deviation for the white noise, different levels of white noise can be generated. From these levels of white noise, a variety of random changes can be obtained using the autoregressive model. In the example, unmeasured process disturbances were first generated by taking the standard deviation as 0.05, then different scale values of λ, equal to 0.01, 0.02 and 0.03 are used to scale the unmeasured disturbances generated from the standard deviation of 0.05 to obtain different degrees of unmeasured disturbances. The scale equation is:

$${X}_{k}^{λ} = 1 + \frac{{X}_{k} - 1}{0.05} λ$$

where λ is the scale value, Xₖ^{λ} is referred to as scaled unmeasured disturbance by λ at time k, and Xₖ is referred to as the disturbance value generated by standard deviation 0.05 at time k. For example, when the scale value, λ, is equal to 0.01, corresponding disturbance is generated by scaling the original unmeasured disturbance with value 0.01.

A background random walk disturbance with a magnitude of 0.005 was applied throughout the modeled plant test except where a large magnitude random walk disturbance was applied.

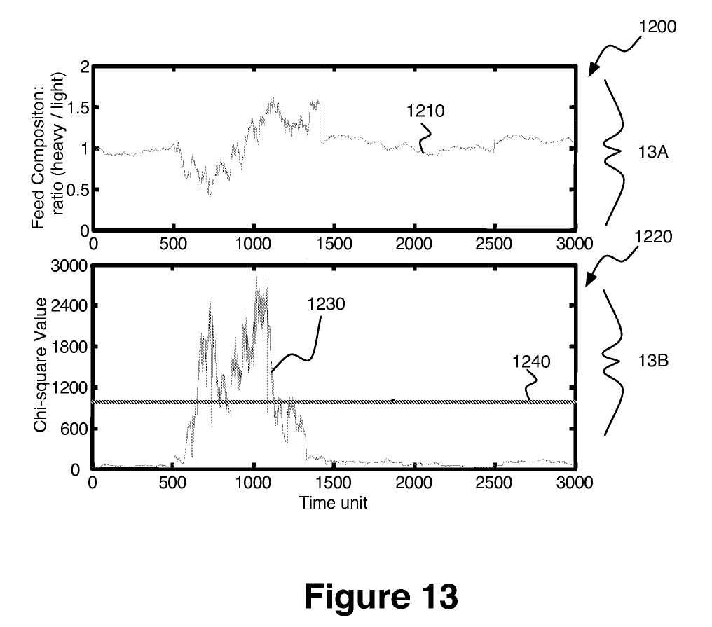

FIG. 13a and FIG. 13b show a 0.03 scaled magnitude random walk disturbance applied between the time unit of 500 and 1300. FIG. 13a is a plot 1200 showing data 1210 of the change in the feed composition ratio over time. The data which is known to be corrupt and is a scaled magnitude random walk disturbance. FIG. 13b is a plot 1220 showing data 1230 of the change in the chi-square value over time after the corrupt data is removed and the asymptotical detection algorithm was applied to the training data set. The results indicate that the ADM was successful in identifying the majority of the time periods during which unmeasured disturbances were present in the test data as shown by the improved threshold 1240.

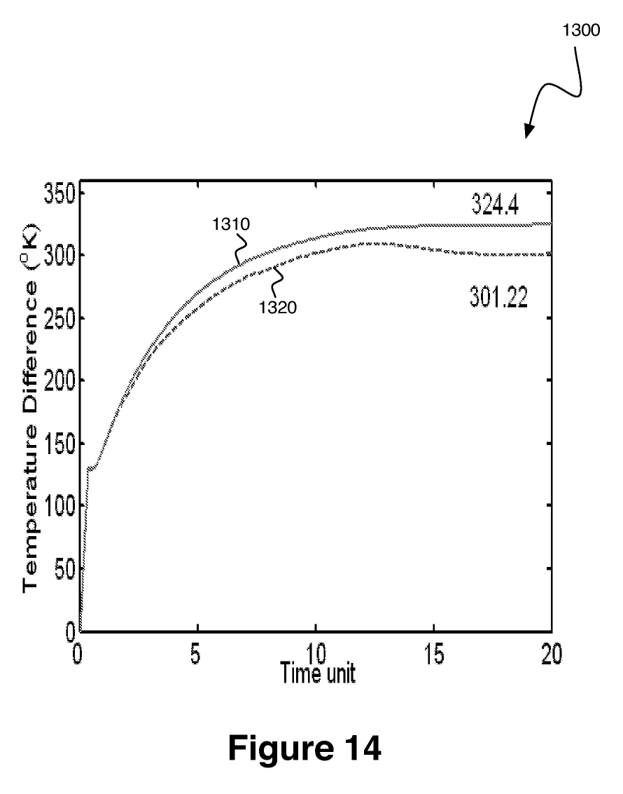

FIG. 14 is a plot 1300 illustrating a model comparison between true model and actual test data for a step change in the unmeasured disturbances. True model data 1310 is shown with test data 1320. Both true model data 1310 and test data 1320 are plotted with time as the X-Axis and the temperature change during the process recorded. The complete set of data was used to identify a MPC model and the corrupted model. The detection method is applied to this plant test data, where the DL is 0.7. Therefore, from this case, ADM was able to identify most of the corrupted training data resulting from single level random walk unmeasured disturbance.

### EXAMPLE 5

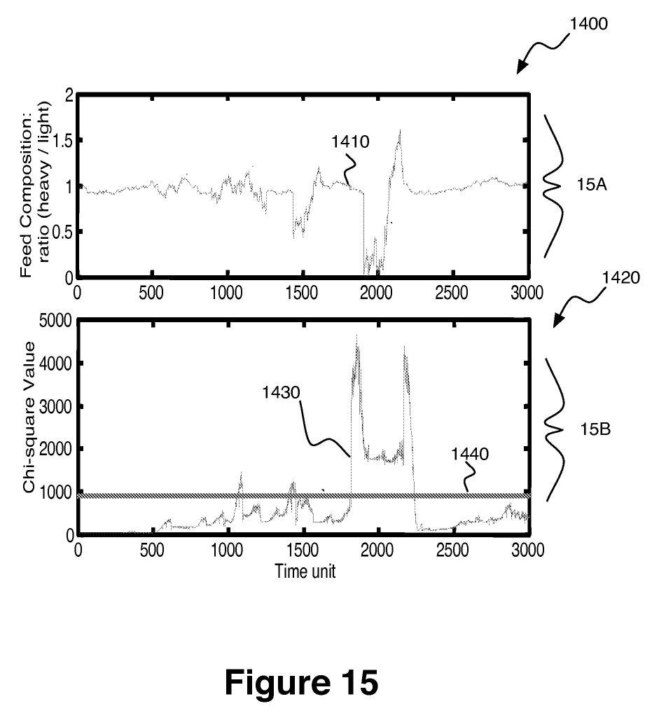

FIG. 15a and FIG. 15b show a multi-degree unmeasured disturbance test MPC plant test was designed that was corrupted by the multiple levels of the random walk unmeasured disturbances. These levels of unmeasured disturbances are scaled by 0.01, 0.02, 0.03, and 0.05. FIG. 15a is a plot 1400 showing data 1410 of the change in the feed composition ratio over time. The data which is known to be corrupt and is a scaled magnitude random walk disturbance. FIG. 15b is a plot 1420 showing data 1430 of the change in the chi-square value over time after the corrupt data is removed and the asymptotical detection algorithm was applied to the training data set. The results indicate that the ADM was successful in identifying the majority of the time periods during which unmeasured disturbances were present in the test data as shown by the improved threshold 1240.

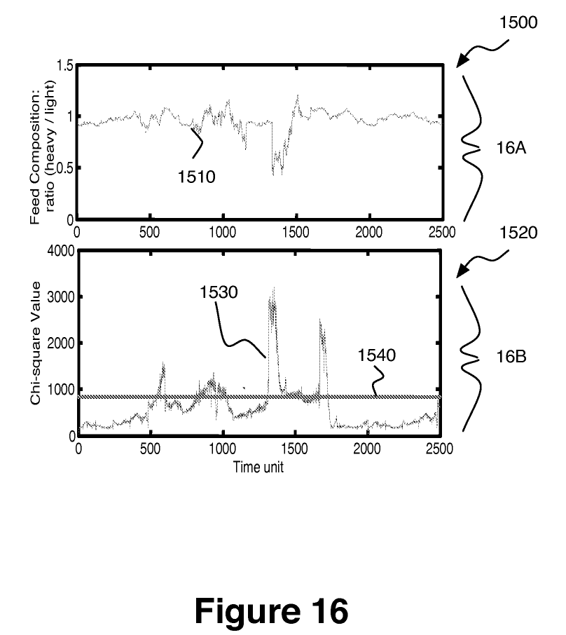

In the example illustrated by FIG. 15a and FIG. 15b, ADM was applied to this training data set where the DL is approximately equal to 0.7. The detection results are shown in FIG. 15b. From this figure, it was found that the detection method was able to identify all the data corrupted by the 0.05 scaled random walk unmeasured disturbance, which was the largest magnitude disturbance used in this case. After the identified corrupted data was removed from the training data set, the detection method was applied to the remaining plant test data set. The application of this method is shown in FIGS. 16a and 15b where the scaled disturbances of 0.01, 0.02, and 0.03 are shown.

FIG. 16a and FIG. 16b show a subset of the disturbances encountered in FIG. 15a, and FIG. 16a and FIG. 16b are created by using the information obtained in FIG. 15a and FIG. 15b. The levels of unmeasured disturbances are scaled by 0.01, 0.02, and 0.03. Unlike FIG. 15a, in FIG. 16a the 0.05 disturbance has been removed and the x-axis of FIG. 16a has been scaled to not show the 0.05 disturbance. FIG. 16a is a plot 1500 showing data 1510 of the change in the feed composition ratio over time. The data which is known to be corrupt and is a scaled magnitude random walk disturbance. FIG. 16b is a plot 1520 showing data 1530 of the change in the chi-square value over time after the corrupt data is removed and the asymptotical detection algorithm was applied to the training data set. The results indicate that the ADM was successful in identifying the majority of the time periods during which unmeasured disturbances were present in the test data as shown by the improved threshold 1540.

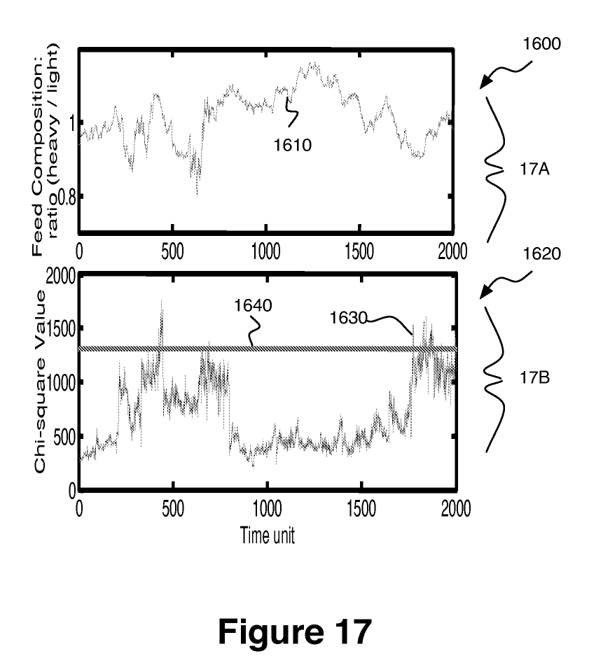

FIG. 17a and FIG. 17b are a third iteration of the ADM for a set of random walk changes in unmeasured disturbances from 0.01 to 0.05. In this iteration, the 0.05 has been removed, and disturbance has been removed and the x-axis of FIG. 16a has been scaled to from 0 to 2000 time units. FIG. 17a is a plot 1600 showing data 1610 of the change in the feed composition ratio over time. The data which is known to be corrupt and is a scaled magnitude random walk disturbance. FIG. 17b is a plot 1620 showing data 1630 of the change in the chi-square value over time after the corrupt data is removed and the asymptotical detection algorithm was applied to the training data set. The results indicate that the ADM was successful in identifying the majority of the time periods during which unmeasured disturbances were present in the test data as shown by the improved threshold 1640.

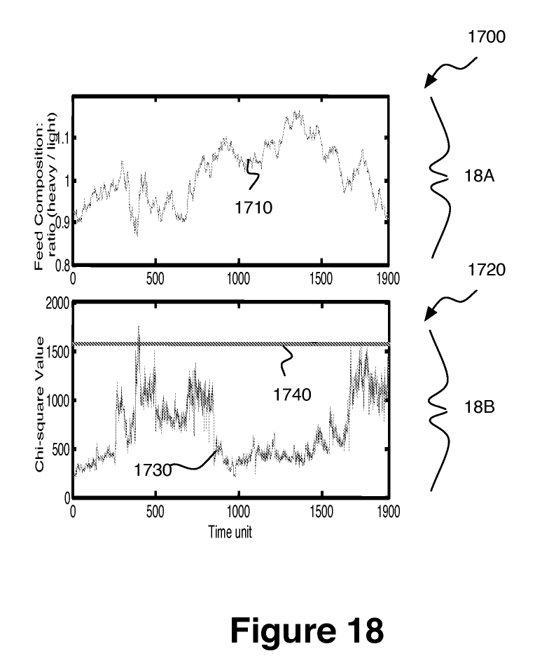

FIG. 18a and FIG. 18b are a fourth iteration of the ADM for a set of random walk changes in unmeasured disturbances from 0.01 to 0.05. In this iteration, the 0.05 has been removed, and disturbance has been removed and the x-axis of FIG. 16a has been scaled to from 0 to 1900 time units. FIG. 18a is a plot 1700 showing data 1710 of the change in the feed composition ratio over time. The data which is known to be corrupt and is a scaled magnitude random walk disturbance. FIG. 18b is a plot 1720 showing data 1730 of the change in the chi-square value over time after the corrupt data is removed and the asymptotical detection algorithm was applied to the training data set. The results indicate that the ADM was successful in identifying the majority of the time periods during which unmeasured disturbances were present in the test data as shown by the improved threshold 1740.

In FIG. 18B, it is shown that most of χ_{global}² values are lower than the threshold, which indicates that the implementation of the detection algorithm can be terminated. Therefore, for the training data set, which was corrupted by the multiple degrees of unmeasured disturbances, the detection algorithm could be applied iteratively to the training data to identify the abnormal training data that would potentially undermine the MPC model until almost all the χ_{global}² values were lower than the improved threshold.

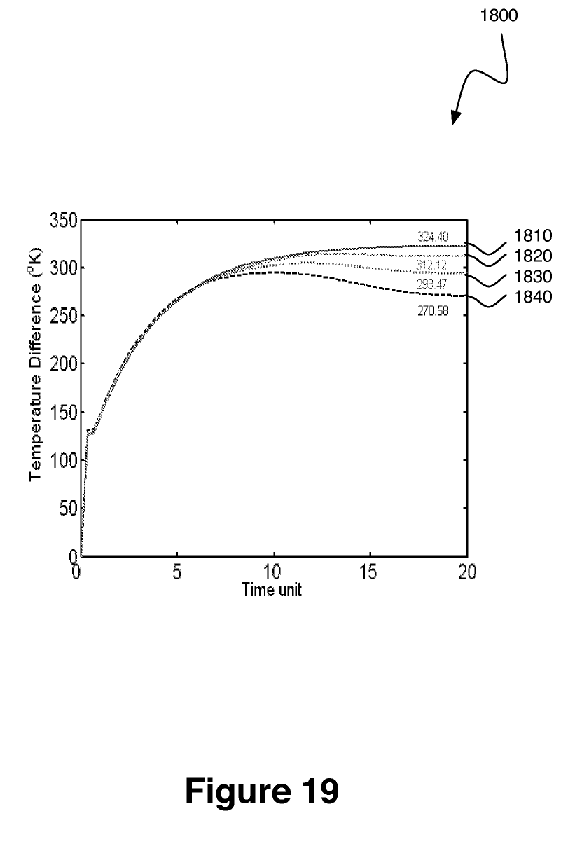

FIG. 19 is a plot 1800 illustrating a model comparison between true model and the improved models. Four sets of data are shown: true model 1810, first improved model 1830, third improved model 1820, and corrupted model based 1840. All four sets are plotted with time as the X-Axis and the temperature change during the process recorded. FIG. 19 shows that each successive iteration produces a MPC model that is closer to the “true” model. Table 2 summarizes the improvement in the model during the iterative application of ADM for this example.

TABLE 2
Comparison of the corrupted model and the multi-improved model

| Model | MSE_{STEP} | Gain difference (%) |
|---|---|---|
| Corrupted model | 915.92 | 16.58 |
| First-improved model | 298.51 | 9.47 |
| Second-improved model | 16.88 | 4.84 |
| Third-improved model | 61.75 | 3.79 |

Note: MSE_{STEP} is the mean square error of the step response model from the true model.

Note that in this case, over 30% of the data was corrupted and yet ADM was able to identify and eliminate the corrupted data. If the majority of the data were corrupted or if the uncorrupted data did not contain adequate information about the response of the process, it may not be realistic to expect ADM to accurately detect the corrupted test data.

### EXAMPLE 6

To evaluate the sensitivity of AMD to measurement noise, the repeatability of the colored sensor noise for the temperature reading and the composition analyzer was increased to ±1.5 K (40% increase compared to the base case level) and ±0.0004 (100% increase compared to the base case level), representing a moderate increase in sensor noise levels. It was found that the ADM was able to iteratively identify the multi-levels of the unmeasured disturbances in a fashion similar to the results shown in FIGS. 15-18. The MPC model was accordingly improved after removing the unmeasured disturbances.

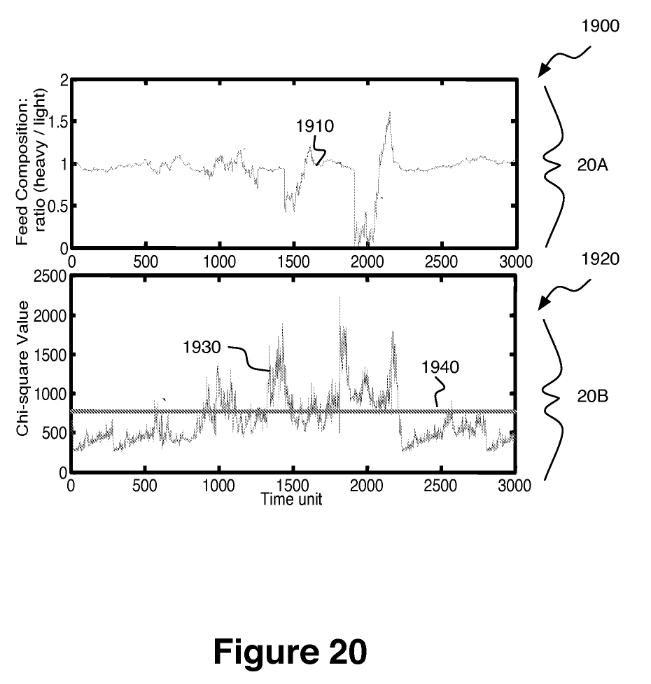

FIG. 20a and FIG. 20b are an application of ADM for a set of random walk changes in unmeasured disturbances scaled from 0.01 to 0.05 for high measurement noise case. When the repeatability of colored sensor noise was increased to ±3.3 K (a 120% increase compared to the base case level) and ±0.0008 (200% increase compared to the base case level), representing a large increase in the sensor noise levels. In this case, the unmeasured disturbance levels scaled by 0.02, 0.03, and 0.05 were all identified in a single χ² test. FIG. 20a is a plot 1900 showing data 1910 of the change in the feed composition ratio over time. The data which is known to be corrupt and is a scaled magnitude random walk disturbance. FIG. 20b is a plot 1920 showing data 1930 of the change in the chi-square value over time after the corrupt data is removed and the asymptotical detection algorithm was applied to the training data set. The results indicate that the ADM was successful in identifying the majority of the time periods during which unmeasured disturbances were present even in high measurement noise cases in the test data as shown by the improved threshold 1940.

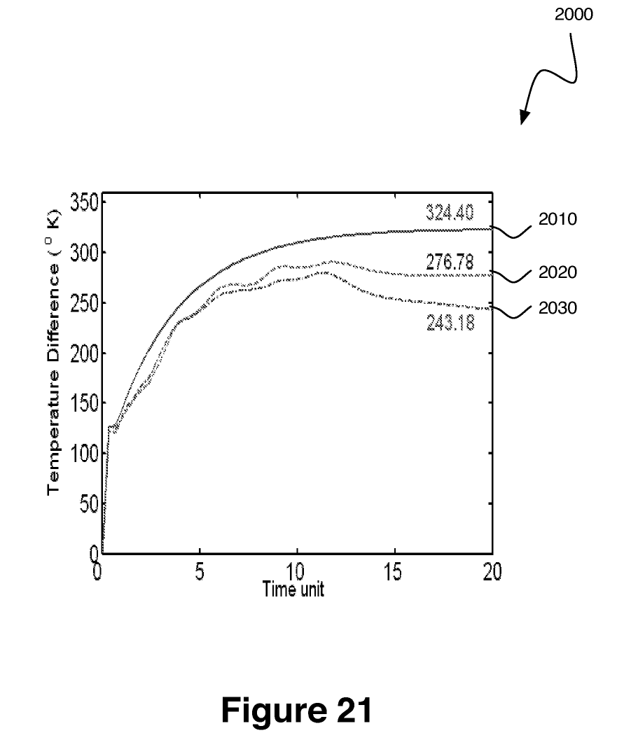

FIG. 21 is a plot 2000 illustrating a model comparison between true model and the improved models. Three sets of data are shown: true model 2010, first improved model 2020, and corrupted model based on all of the test data 2030. All three sets are plotted with time as the X-Axis and the temperature change during the process recorded. This plot shows the improvement made after slicing bad data for high measurement noise case.

Note that even after the corrupted data was removed from the test results, the regressed MPC model showed significant mismatch when compared to the ‘true model’. This results because the training data is corrupted by large magnitude colored noise. The results for a moderate and a large increase in the sensor noise indicate that the ADM does not appear to be adversely affected by sensor noise levels.

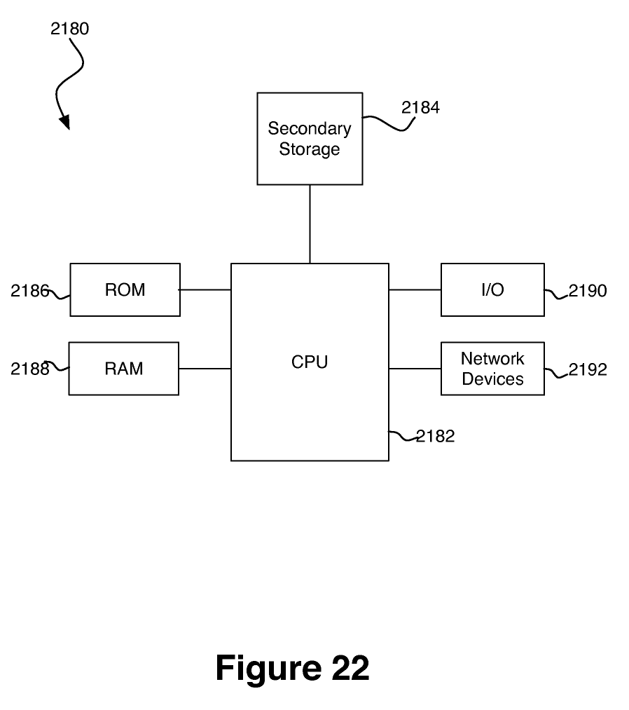

The modeling system for detecting unmeasured disturbances 10 described above may be implemented on any general-purpose computer 2180 with sufficient processing power, memory resources, and network throughput capability to handle the necessary workload placed upon it. A user home personal computer, networked to a central modeling system for detecting unmeasured disturbances 10 through a wide area network, such as the Internet, may be used in conjunction with the disclosed embodiments. The user home personal computer may share some, or all, of the elements of modeling system for detecting unmeasured disturbances 10. FIG. 22 illustrates a typical, general-purpose computer system suitable for implementing one or more embodiments disclosed herein. The general-purpose computer 2180 includes a processor 2182 (which may be referred to as a central processor unit or CPU) that is in communication with memory devices including secondary storage 2184, read only memory (ROM) 2186, random access memory (RAM) 2188, input/output (I/O) 2190 devices, and network connectivity devices 2192. The processor may be implemented as one or more CPU chips.

The secondary storage 2184 is typically comprised of one or more disk drives or tape drives and is used for non-volatile storage of data and as an over-flow data storage device if RAM 2188 is not large enough to hold all working data. Secondary storage 2184 may be used to store programs which are loaded into RAM 2188 when such programs are selected for execution. The ROM 2186 is used to store instructions and perhaps data which are read during program execution. ROM 2186 is a non-volatile memory device which typically has a small memory capacity relative to the larger memory capacity of secondary storage. The RAM 2188 is used to store volatile data and perhaps to store instructions. Access to both ROM 2186 and RAM 2188 is typically faster than to secondary storage 2184.

I/O 2190 devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices 2192 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity 2192 devices may enable the processor 2182 to communicate with an Internet or one or more intranets. With such a network connection, it is contemplated that the processor 2182 might receive information from the network, or might output information to the network in the course of performing the above-described method steps. Such information, which is often represented as a sequence of instructions to be executed using processor 2182, may be received from and outputted to the network, for example, in the form of a computer data signal embodied in a carrier wave.

Such information, which may include data or instructions to be executed using processor 2182 for example, may be received from and outputted to the network, for example, in the form of a computer data baseband signal or signal embodied in a carrier wave. The baseband signal or signal embodied in the carrier wave generated by the network connectivity devices 2192 may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 2182 executes instructions, codes, computer programs, scripts which it accesses from hard disk, floppy disk, optical disk (these various disk based systems may all be considered secondary storage 2184), ROM 2186, RAM 2188, or the network connectivity devices 2192.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

While embodiments have been shown and described, modifications thereof can be made by one skilled in the art without departing from the spirit and teachings of the disclosure. The embodiments described herein are exemplary only, and are not intended to be limiting. Many variations and modifications are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment. Thus, the claims are a further description and are an addition to the embodiments. The discussion of a reference herein is not an admission that it is prior art, especially any reference that may have a publication date after the priority date of this application. The disclosures of all patents, patent applications, and publications cited herein are hereby incorporated by reference, to the extent that they provide exemplary, procedural, or other details supplementary to those set forth herein.

What is claimed is:

1. A method of improving a data set associated with a system, the method comprising:
providing a baseline data set for the system, wherein the baseline data set comprises a plurality of input and output data from the system;
analyzing the baseline data set and selecting a baseline model for the baseline data set, wherein the baseline model comprises an baseline array of data relating to the input and output data from the system;
normalizing the baseline data set associated with the system to create a normalized data set;
analyzing the normalized data set and selecting an improved model for the normalized data set, wherein the improved model comprises an improved array of data relating to the input and output data from the system;
performing a statistical comparison using the baseline data set and the normalized data set;
calculating an at least one indicator value associated with the normalized and baseline data set based on the statistical comparison;
determining a threshold value associated with the baseline data set and normalized data set based on the statistical comparison; and
producing a new data set by eliminating any segments of the baseline data set where the at least one indicator value is greater than the threshold value.

2. The method of claim 1 wherein the eliminated data segments are associated with abnormal operating conditions of the system.

3. The method of claim 1 wherein abnormal operating conditions of the system are associated with unmeasured disturbances of the system.

4. The method of claim 1, further comprising:
iteratively repeating the method of claim 1 at least once, wherein the new data set is used as the baseline data set in at least one iteration.

5. The method of claim 1, wherein normalizing the baseline data set comprises linearizing the baseline data set to create the improved data set.

6. The method of claim 1, wherein the at least one indicator value is calculated through the statistical comparison of the baseline data set and the improved data set using a global chi-squared value.

7. The method of claim 1, wherein the at least one indicator value is derived from a false alarm rate.

8. The method of claim 6, wherein the threshold value is an improved chi-squared threshold value.

9. The method of claim 1, wherein the at least one model of the system comprises a model predictive control model, a Finite Impulse Response (FIR) model, a transfer function model, a state-space model, or combination thereof.

10. The method of claim 1, wherein the at least one model of the system is a model predictive control model that further comprises a single-input single-output (SISO) model, a multiple-input multiple-output (MIMO) model, a single-input multiple-output (SIMO) model, a multiple-input single-output (MISO) model, or combinations thereof.

11. The method of claim 5, wherein the identification of the at least one model of the system is based upon the degree of linearization of the baseline data set.

12. The method of claim 1, further comprising simulating operation of the system using the model of the system and the new data set.

13. The method of claim 1, further comprising controlling operation of the system using one or more results of the simulation.

14. The method of claim 13, wherein the controlling operation of the system comprises model predictive control.

15. The method of claim 13, wherein the system is one or more operating units of a petroleum refining and/or chemical manufacturing plant.

16. The method of claim 15, wherein the baseline data set is gathered from one or more test runs of the one or more operating units.

17. A system for identifying unmeasured disturbances in a process comprising:
a data entry unit, wherein the data entry unit accepts a baseline data set associated with the process, selects a baseline model for the baseline data set, normalizes the baseline data set and creates an improved data set from the normalized baseline data set, and selects an improved model for the improved data set;
a modeling unit, wherein the modeling unit calculates a statistical threshold value using the baseline data set and the improved data set calculates an indicator value using the baseline data set and the improved data set, and produces a new data set by eliminating any data in the baseline data set in which the indicator value is greater than the statistical threshold value; and
a data output unit, wherein the data output unit outputs the new data set to a computer readable medium.

18. A process control device capable of implementing model predictive control of a process, the process control device performing a method comprising:
identifying a first model predictive control model using a training data set associated with the process;
identifying a second model predictive control model using a linearized training data set;
statistically comparing the results of the first model predictive control model and the second model predictive control model;
detecting differences in the statistical comparison of the first model predictive control model and the second model predictive control model;
producing a new data set by eliminating any data in the training data set based upon the differences in the first model predictive control model and the second model predictive control model.

19. The process control device of claim 18 further comprising:
iteratively performing the process control device method using the new data as training data set.

20. The process control device of claim 18 wherein the statistical comparison is preformed through a chi-squared function.

21. The process control device of claim 18 wherein the new data is created by removing data from the training data set.

22. A method of identifying unmeasured disturbances in model predictive control test data comprising:
identifying a first model predictive control model using a training data set;
identifying a second model predictive control model using an improved training data set;
calculating a global chi-squared value using the first model predictive control model, the second model predictive control model, the training data set, and the improved training data set;
calculating an improved chi-squared threshold value; and
producing a new data set by eliminating any data in the training data set in which the global chi-squared value is greater than the improved chi-squared threshold value.

23. The method of claim 22 further comprising iteratively repeating the method until all of the global chi-squared values are less than or equal to the improved chi-squared threshold values.

24. The method of claim 22 wherein the first model predictive control model, the second model predictive control model, or both are obtained using least-squares regression method.

25. The method of claim 22 wherein the improved version of the training data set is obtained by piecewise linearizing the training data set.
